(19) United States
(12) Patent Application Publication
(10) Pub. No.: US 2025/0016684 A1
(43) Pub. Date: Jan. 9, 2025

(54) COMMUNICATION COORDINATION BETWEEN ENERGY HARVESTING USER EQUIPMENT AND WIRELESS NETWORKS

(71) Applicant: QUALCOMM Incorporated, San Diego, CA (US)

(72) Inventors: Linhai HE, San Diego, CA (US); Ahmed ELSHAFIE, San Diego, CA (US); Seyedkianoush HOSSEINI, San Diego, CA (US); Yuchul KIM, San Diego, CA (US); Zhikun WU, Beijing (CN); Huilin XU, Temecula, CA (US)

(21) Appl. No.: 18/711,762

(22) PCT Filed: Jan. 7, 2022
(86) PCT No.: PCT/CN2022/070706

§ 371 Date: May 20, 2024

(51) Int. Cl. H04W 52/02; H02J 50/00

(52) U.S. Cl. CPC H04W 52/0251; H02J 50/001

(57) ABSTRACT

Wireless communications systems and methods related to communicating control information are provided. A method of wireless communication performed by a user equipment (UE) may include harvesting energy from an ambient environment associated with the UE and transmitting, to a base station (BS), a communication associated with a communication opportunity, wherein the communication opportunity is based on parameters associated with the harvesting of the energy from the ambient environment.

### TECHNICAL FIELD

This application relates to wireless communication systems, and more particularly, to coordinating communications between energy harvesting user equipment and wireless networks.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed frequency bands and/or unlicensed frequency bands (e.g., shared frequency bands).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a user equipment (UE) may include harvesting energy from an ambient environment associated with the UE and transmitting, to a base station (BS), a communication associated with a communication opportunity. The communication opportunity may be based on parameters associated with the harvesting of the energy from the ambient environment.

In an additional aspect of the disclosure, a method of wireless communication performed by a base station (BS) may include receiving, from a user equipment (UE), a communication associated with a communication opportunity. The communication opportunity may be based on parameters associated with energy harvesting by the UE and communicating, with the UE, one or more transport blocks (TBs) based on the communication opportunity.

In an additional aspect of the disclosure, a user equipment (UE) may include a memory: a transceiver; and at least one processor coupled to the memory and the transceiver, wherein the UE is configured to harvest energy from an ambient environment associated with the UE and transmit, to a base station (BS), a communication associated with a communication opportunity. The communication opportunity may be based on parameters associated with the harvesting of the energy from the ambient environment.

In an additional aspect of the disclosure, a base station (BS) may include a memory; a transceiver; and at least one processor coupled to the memory and the transceiver, wherein the BS is configured to receive, from a user equipment (UE), a communication associated with a communication opportunity, wherein the communication opportunity is based on parameters associated with energy harvesting by the UE and communicate, with the UE, one or more transport blocks (TBs) based on the communication opportunity.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates an energy harvesting UE in a wireless communication network according to some aspects of the present disclosure.

FIGS. 3-5 illustrate communication opportunities according to some aspects of the present disclosure.

FIG. 6 is a signaling diagram of a wireless communication method according to some aspects of the present disclosure.

FIG. 7 is a signaling diagram of a wireless communication method according to some aspects of the present disclosure.

FIG. 8 is a block diagram of an exemplary user equipment (UE) according to some aspects of the present disclosure.

FIG. 9 is a block diagram of an exemplary base station (BS) according to some aspects of the present disclosure.

FIG. 10 is a flow diagram of a communication method according to some aspects of the present disclosure.

FIG. 11 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations: (2) including mission-critical control with strong security to safeguard sensitive personal, financial, or classified information, ultra-high reliability (e.g., ˜99.9999% reliability), ultra-low latency (e.g., ˜ 1 ms), and users with wide ranges of mobility or lack thereof: and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI): having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mm Wave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U can also be deployed over 2.4 GHz unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum. However, channel access in a certain unlicensed spectrum may be regulated by authorities. For instance, some unlicensed bands may impose restrictions on the power spectral density (PSD) and/or minimum occupied channel bandwidth (OCB) for transmissions in the unlicensed bands. For example, the unlicensed national information infrastructure (UNII) radio band has a minimum OCB requirement of about 70 percent (%).

Some sidelink systems may operate over a 20 MHz bandwidth in an unlicensed band. A BS may configure a sidelink resource pool over the 20 MHz band for sidelink communications. A sidelink resource pool is typically partitioned into multiple frequency subchannels or frequency subbands (e.g., about 5 MHz each) and a sidelink UE may select a sidelink resource (e.g., a subchannel) from the sidelink resource pool for sidelink communication. To satisfy an OCB of about 70%, a sidelink resource pool may utilize a frequency-interlaced structure. For instance, a frequency-interlaced-based sidelink resource pools may include a plurality of frequency interlaces over the 20 MHz band, where each frequency interlace may include a plurality of resource blocks (RBs) distributed over the 20 MHz band. For example, the plurality of RBs of a frequency interlace may be spaced apart from each other by one or more other RBs in the 20 MHz unlicensed band. A sidelink UE may select a sidelink resource in the form of frequency interlaces from the sidelink resource pool for sidelink communication. In other words, sidelink transmissions may utilize a frequency-interlaced waveform to satisfy an OCB of the unlicensed band. However, S-SSBs may be transmitted in a set of contiguous RBs, for example, in about eleven contiguous RBs. As such, S-SSB transmissions alone may not meet the OCB requirement of the unlicensed band. Accordingly, it may be desirable for a sidelink sync UE to multiplex an S-SSB transmission with one or more channel state information reference signals (CSI-RSs) in a slot configured for S-SSB transmission so that the sidelink sync UE's transmission in the slot may comply with an OCB requirement.

The present application describes mechanisms for a sidelink UE to multiplex an S-SSB transmission with a CSI-RS transmission in a frequency band to satisfy an OCB of the frequency band. For instance, the sidelink UE may determine a multiplex configuration for multiplexing a CSI-RS transmission with an S-SSB transmission in a sidelink BWP. The sidelink UE may transmit the S-SSB transmission in the sidelink BWP during a sidelink slot. The sidelink UE may transmit one or more CSI-RSs in the sidelink BWP during the sidelink slot by multiplexing the CSI-RS and the S-SSB transmission based on the multiplex configuration.

In some aspects, the sidelink UE may transmit the S-SSB transmission at an offset from a lowest frequency of the sidelink BWP based on a synchronization raster (e.g., an NR-U sync raster). In some aspects, the sidelink UE may transmit the S-SSB transmission aligned to a lowest frequency of the sidelink BWP. For instance, a sync raster can be defined for sidelink such that the S-SSB transmission may be aligned to a lowest frequency of the sidelink BWP.

In some aspects, the multiplex configuration includes a configuration for multiplexing the S-SSB transmission with a frequency interlaced waveform sidelink transmission to meet the OCB requirement. For instance, the sidelink transmission may include a CSI-RS transmission multiplexed in frequency within a frequency interlace with RBs spaced apart in the sidelink BWP. In some instances, the sidelink UE may rate-match the CSI-RS transmission around RBs that are at least partially overlapping with the S-SSB transmission.

In some aspects, the multiplex configuration includes a configuration for multiplexing the S-SSB transmission with a subchannel-based sidelink transmission to meet the OCB requirement. For instance, the sidelink transmission may include a CSI-RS transmission multiplexed in time within a subchannel including contiguous RBs in the sidelink BWP. For instance, the S-SSB transmission may be transmitted at a low frequency portion of the sidelink BWP, and the CSI-RS may be transmitted in a subchannel located at a high frequency portion of the sidelink BWP to meet the OCB.

In some aspects, a BS may configure different sidelink resource pools for slots that are associated with S-SSB transmissions and for slots that are not associated with S-SSB transmissions. For instance, the BS may configure a first resource pool with a frequency-interlaced structure for slots that are not configured for S-SSB transmissions. The first resource pool may include a plurality of frequency interlaces (e.g., distributed RBs), where each frequency interlace may carry a PSCCH/PSSCH transmission. The BS may configure a second resource pool with a subchannel-based structure for slots that are configured for S-SSB transmission. The second resource pool may include a plurality of frequency subchannels (e.g., contiguous RBs), where each subchannel may carry a PSCCH/PSSCH transmission. To satisfy an OCB in a sidelink slot configured for an S-SSB transmission, the sidelink UE (e.g., a sidelink sync UE) may transmit an S-SSB transmission multiplexed with a CSI-RS transmission. For instance, the S-SSB transmission may be transmitted in frequency resources located at a lower frequency portion of a sidelink BWP and the CSI-RS transmission may be transmitted in frequency resources located at higher frequency portion of the sidelink BWP.

In some aspects, the UE may harvest energy from an ambient environment associated with the UE. The UE may transmit a communication to the BS associated with a communication opportunity. The communication opportunity may be based on parameters associated with the harvesting of the energy from the ambient environment. Aspects of the present disclosure may overcome the challenges of limited energy availability in the UE by using methods for coordinating communication between the energy harvesting UE and the BS. In this regard, the energy harvested by the UE may be used to communicate with the BS.

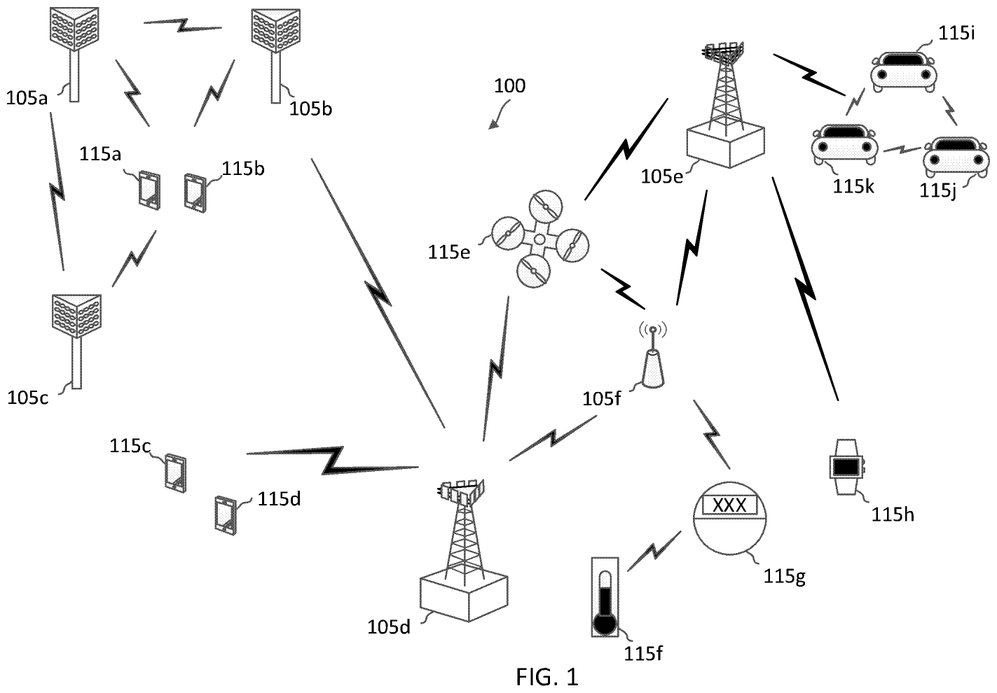

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

In some aspects, the UE 115h may harvest energy from an ambient environment associated with the UE 115h. The UE 115h may transmit a communication to the BS 105e associated with a communication opportunity. The communication opportunity may be based on parameters associated with the harvesting of the energy from the ambient environment. Aspects of the present disclosure may overcome the challenges of limited energy availability in the UE 115h by using methods for coordinating communication between the energy harvesting UE 115h and the BS 105e. In this regard, the energy harvested by the UE 115h may be used to communicate with the BS 105e.

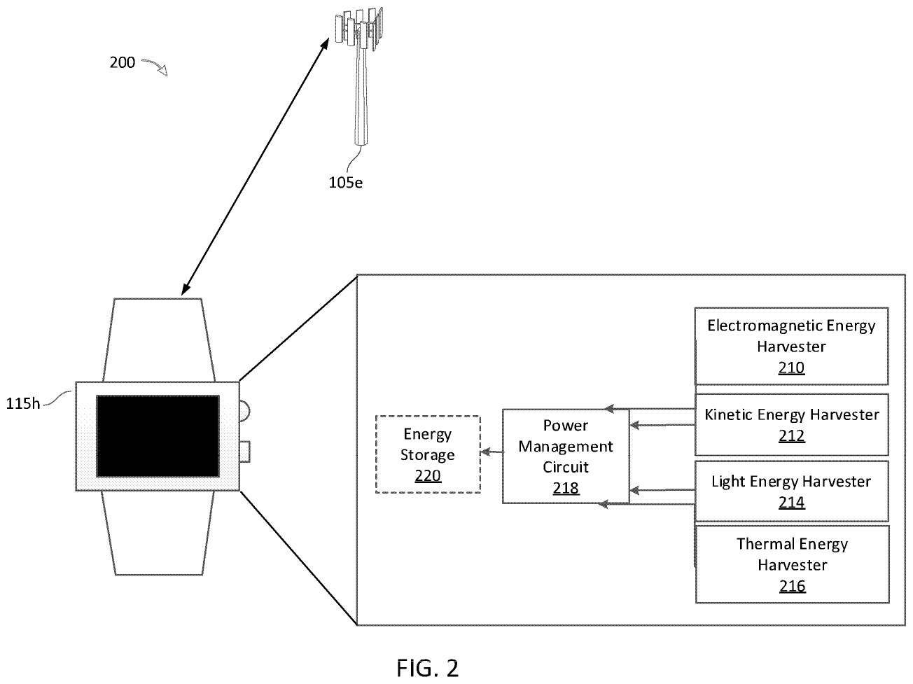

FIG. 2 illustrates a wireless communication network 200 according to some aspects of the present disclosure. The wireless communications network 200 may include a base station 105e and energy harvesting UE 115h which may be examples of a BS 105 and a UE 115 as described with reference to FIG. 1. The UE 115h may harvest energy from an ambient environment associated with the UE 115h. In this regard, the UE 115h may harvest energy from the ambient environment using any suitable method. For example, the UE 115h may harvest (e.g., derive) energy from external sources to provide power (e.g., operating power) to the UE 115h. The UE 115h may harvest energy from a light source (e.g., solar radiation, photovoltaic cells, artificial light sources, etc.) using light energy harvester 214, an electromagnetic energy source (e.g., cellular communications, WiFi communications, NFC/RFID communications, magnetic induction, 50/60 Hz line radiation, etc.) using electromagnetic energy harvester 210, a kinetic energy source (e.g., mechanical vibration, touchscreen press, piezoelectric source, UE 115h motion, wearable device motion, etc.) using kinetic energy harvester 212, a thermoelectric source (e.g., user body heat, IoT device heat, ambient environment heat, etc.) using thermal energy harvester 216. In some aspects, the energy harvested by the electromagnetic energy harvester 210, the kinetic energy harvester 212, the light energy harvester 214, or the thermal energy harvester 216 may be conditioned by power management circuit 218.

In some aspects, the energy harvested from the ambient environment may be stored in the UE 115h. For example, the harvested energy may be stored in energy storage 220. Energy storage 220 may include one or more batteries, capacitors, and/or other suitable storage devices. In some aspects, the UE 115h may not have energy storage 220 and the energy harvested from the ambient environment may be used by the UE 115h as the energy is harvested. The amount of energy available to the UE 115h for communications with the BS 105e and/or other actions may be limited by the energy storage capacity, the amount of energy available in the ambient environment, and/or the energy harvesting method. Aspects of the present disclosure may overcome the challenges of limited energy availability in the UE 115h using methods for coordinating communication between energy harvesting UE 115h and the BS 105e. In this regard, the energy harvested by the UE 115h may be used to communicate with the BS 105e.

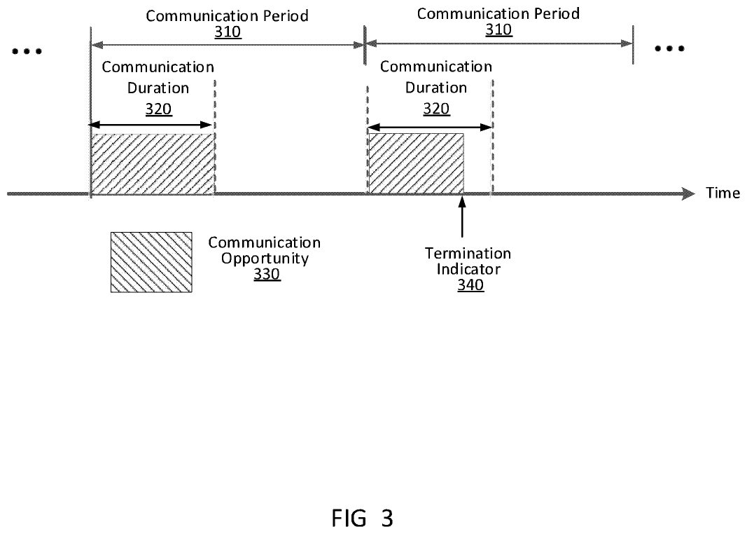

FIG. 3 illustrates communication opportunities associated with an energy harvesting UE (e.g., the UE 115h or the UE 800) according to some aspects of the present disclosure. In FIG. 3, the x-axis represents time in some arbitrary units. In some aspects, a UE may transmit a communication associated with a communication opportunity 330 to a BS (e.g., the BS 105e or the BS 900). The communication opportunity 330 may be based on parameters associated with the energy harvested by the UE from the ambient environment. In this regard, the UE may transmit the communication associated with the communication opportunity 330 to the BS via a physical uplink control channel (PUCCH), a physical uplink shared channel (PUSCH), uplink control information (UCI), or other suitable communication.

In some aspects, the communication associated with the communication opportunity 330 may include an indication of a communication periodicity 310 and/or an indication of a communication duration 320. In some instances, the UE may wakeup from a low power mode (e.g., a sleep mode) to communicate with the BS based on the communication periodicity 310. The communication periodicity 310 may define a communication periodicity 310 having a start and/or an end. In some instances, the UE may wakeup at the start and/or offset from the start of the communication periodicity 310. In some aspects, the communication periodicity 310 may be based on the energy harvesting. For example, the communication periodicity 310 or the amount of time between each communication periodicity 310 may be based on how much energy the UE harvested during a previous time period and/or an estimate of how much energy the UE will harvest during a future time period. Additionally or alternatively, the communication duration 320 may be based on the energy harvesting. For example, the communication duration 320 or the amount of time the UE is in a wake state during each communication periodicity 310 may be based on how much energy the UE harvested during a previous time period, how much harvested energy is stored in the UE, and/or an estimate of how much energy the UE will harvest during a future time period. The UE may communicate with the BS and/or directly with other UEs via sidelink communications when the UE is in the wake state during the communication duration 320. The communication opportunity 330 may include a plurality of communication opportunities 330 occurring at a frequency based on the communication periodicity 310.

The UE may transmit communications to the BS and/or receive communications from the BS during the communication opportunity 330. The UE may transmit one or more transport blocks (TBs) to the BS via a PUSCH during the communication opportunity 330. The UE may receive one or more TBs from the BS via a PDSCH during the communication opportunity 330.

In some aspects, the UE may determine the communication periodicity 310 and/or the communication duration 320. The UE may transmit an indication of the communication periodicity 310 and/or the communication duration 320 to the BS via a PUCCH, a PUSCH, UCI, an RRC message, a MAC-CE message, or other suitable communication. In some aspects, the indication of the communication periodicity 310 and/or the communication duration may include a time value (e.g., a number of ms), a multiple or a fraction of a frame, a multiple or a fraction of a subframe, a multiple or a fraction of a slot, a multiple or a fraction of a sub-slot, a multiple or a fraction of a TTI, or a multiple or a fraction of a symbol. In some aspects, the indication of the communication periodicity and/or the communication duration may include a bitmap and/or a codepoint corresponding to a time value. The UE may determine the communication periodicity 310 and/or the communication duration 320 using any suitable method. For example, the UE may determine the communication periodicity 310 and/or the communication duration 320 based on the energy harvesting capabilities of the UE and/or the energy storage capabilities of the UE. A UE with a higher energy harvesting capability and/or energy storage capability may have a shorter communication periodicity 310 and/or a longer communication duration 320 compared to a UE having a lower energy harvesting capability and/or energy storage capability. In some aspects, the UE may determine the communication periodicity 310 and/or the communication duration 320 based on a scheduled and/or estimated amount of data/control communications and the amount of energy required for the data/control communications. For example, the UE may be an IoT device scheduled to transmit/receive a number of TBs during a time frame.

The UE may determine the communication periodicity 310 and/or the communication duration 320 based on an estimated amount of energy required to transmit and/or receive the TBs (e.g., joules per bit of data). In some aspects, the communication periodicity 310 and/or the communication duration 320 may be scheduled by the UE on a semi-persistent basis. The UE may update the communication periodicity 310 and/or the communication duration 320 schedule based on operating conditions, energy harvesting, and/or the amount of data to be communicated. The UE may transmit an indication of an updated communication periodicity 310 and/or communication duration 320 to the BS on a periodic and/or aperiodic basis. In some aspects, the indication of an updated communication periodicity 310 and/or communication duration 320 may include a change field (e.g., a codepoint) where “0” indicates no change in the communication periodicity 310 and/or communication duration 320 and “1” indicates a change in the communication periodicity 310 and/or communication duration 320. If the change field is set to “1”, the UE may transmit the updated communication periodicity 310 and/or communication duration 320 in addition to the change field. For example, when the harvested energy, the stored energy, and/or the amount of TBs to be communicated increases, the UE may decrease the communication periodicity 310 (e.g., increasing the frequency of communication) and/or increase the communication duration 320. When the harvested energy, the stored energy, and/or the amount of TBs to be communicated decreases, the UE may increase the communication periodicity 310 (e.g., decreasing the frequency of communication) and/or decrease the communication duration 320.

Additionally or alternatively, the communication associated with the communication opportunity 330 may include an indication of a communication periodicity 310 and an indication of a communication duty cycle. The communication duty cycle may be indicated as a percent and/or a fraction of the communication period 310. For example, the communication duty cycle may be the communication duration 320 divided by the communication period 310.

In some aspects, the UE may transmit a termination indicator 340 to the BS indicating an early termination of a communication duration. The UE may transmit the communication termination indicator 340 based on the UE having transmitted all the data in the UE's buffer. Additionally or alternatively, the UE may transmit the communication termination indicator 340 based on the UE having a low usable energy level (e.g., the stored and/or harvested energy is below a threshold) and/or other power parameters associated with the UE. In this regard, the UE may transmit the communication termination indicator 340 in a PUCCH communication, a PUSCH communication, UCI, an UL DRX MAC CE, or other suitable communication. In some aspects, the communication termination indicator 340 may be a codepoint (e.g., a single bit 0 or 1) indicating whether the communication duration should be terminated before the end of the scheduled communication duration. In some instances, the codepoint may be indicated via a PUCCH message and/or multiplexed with HARQ feedback to the BS.

Additionally or alternatively, the termination indicator 340 may be an indication (e.g., an explicit indication) of when the communication duration should terminate (e.g., a time to when the UE enters a sleep state). The termination indicator 340 may be an amount of time from the start of the communication duration, an amount of time from the end of the communication duration, a delta amount of time from a previous termination indicator 340, or other suitable termination indicator 340. In some aspects, the termination indicator 340 may include a time value (e.g., a number of ms), a multiple or a fraction of a frame, a multiple or a fraction of a subframe, a multiple or a fraction of a slot, a multiple or a fraction of a sub-slot, a multiple or a fraction of a TTI, or a multiple or a fraction of a symbol. In some aspects, the indication of the termination indicator 340 may include a bitmap and/or a codepoint corresponding to a time value.

In some aspects, the BS may indicate an early termination of a communication duration. In this regard, the BS may indicate the termination indicator 340 via a DRX MAC CE message, a time to dormancy (TTD) MAC CE message, a MAC CE message, and/or DCI. In some aspects, the BS may transmit the termination indicator 340 to the UE indicating when to terminate the communication (e.g., early termination) based on when the BS has no more data to transmit to the UE. The UE may enter a sleep state after receiving the communication duration termination indicator 340 from the BS.

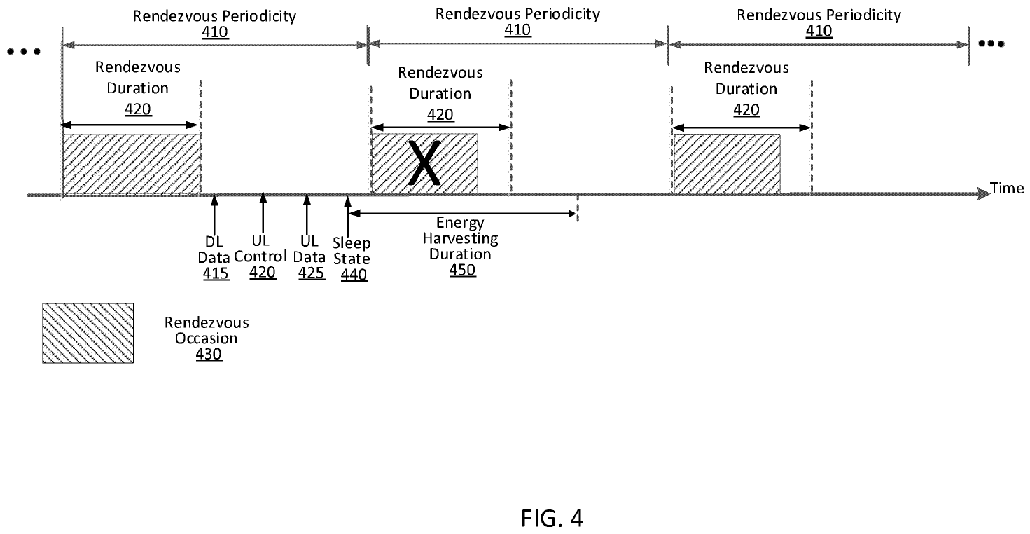

FIG. 4 illustrates communication opportunities associated with an energy harvesting UE (e.g., the UE 115h or the UE 800) according to some aspects of the present disclosure. In FIG. 4, the x-axis represents time in some arbitrary units. In some aspects, the BS and the UE may establish (e.g., preconfigure) a sequence of rendezvous occasions 430. The BS and UE may communicate with each other during the rendezvous occasions 430. Each rendezvous occasion 430 may have a fixed or variable rendezvous duration 420. The rendezvous occasions 430 may occur at a fixed or variable rendezvous periodicity 410. The timing of the rendezvous occasions 430 may be synchronized between the UE and the BS such that the UE and the BS are both in a wake state during the rendezvous occasions 430. In some aspects, the UE may transmit a rendezvous occasion 430 schedule including a rendezvous duration 420 and periodicity 410 to the BS. In response, the BS may confirm the rendezvous occasion 430 schedule or transmit a different rendezvous occasion 430 schedule to the UE. In some aspects, when the UE and BS do not have data to communicate, the UE may enter a sleep state. For example, the UE may wake up during a rendezvous occasion 430 and receive an indicator (e.g., a BSR) from the BS indicating the BS has no data to transmit to the UE. In response to the indicator indicating the BS has no data to transmit, the UE may enter a sleep state and remain in the sleep state until the next rendezvous occasion 430. In some aspects, when either the UE or the BS has data to communicate, the UE may wakeup during the rendezvous occasion 430 and remain in a wake state until there is no more data to communicate and/or the energy associated with the UE has fallen below a threshold. For example, the UE may wakeup during the rendezvous occasion 430 and remain in a wake state while receiving DL data 415, transmitting UL control 420, and/or transmitting UL data 425. In some aspects, the UE may transmit an indicator (e.g., a BSR) to the BS indicating when the UE expects to have no more data to communicate or when the energy associated with the UE is expected to fall below the threshold.

In some aspects, the UE may enter or remain in a sleep state for an energy harvesting duration 450 (e.g., a minimum duration) after the rendezvous occasion 430. The UE may enter or remain in a sleep state for the energy harvesting duration 450 after the rendezvous occasion 430 based on the UE's energy level falling below a threshold. During the sleep state after the rendezvous occasion 430, the UE may harvest energy from the ambient environment. The UE may remain in the sleep state and harvest energy until the UE has harvested enough energy to enter another rendezvous occasion 430. The energy harvesting duration 450 may be preconfigured (e.g., the duration is stored in the UE) and/or determined by the UE based on the rate of energy harvesting. The energy harvesting duration 450 may be indicated to the BS in a MAC CE message and/or UCI. In some aspects, the UE may skip all of the rendezvous occasions 430 scheduled during the energy harvesting duration. For example, the rendezvous occasion 430 indicated by X in FIG. 3 may be skipped based on the UE entering a sleep state 440.

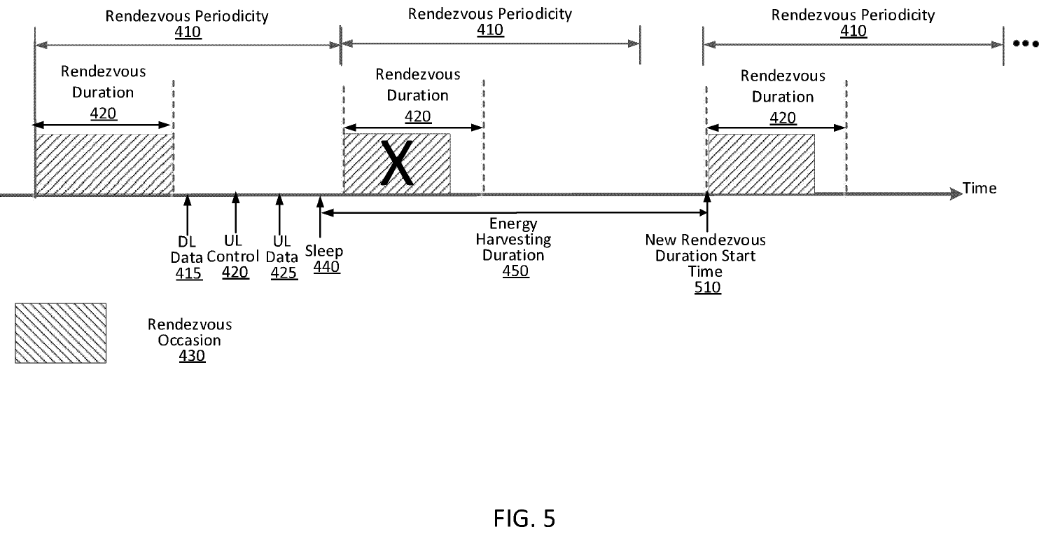

FIG. 5 illustrates communication opportunities associated with an energy harvesting UE (e.g., the UE 115h or the UE 800) according to some aspects of the present disclosure. In FIG. 5, the x-axis represents time in some arbitrary units. In some aspects, the BS and the UE may establish (e.g., preconfigure) a sequence of rendezvous occasions 430. The BS and UE may communicate with each other during the rendezvous occasions 430. Each rendezvous occasion 430 may have a fixed or variable rendezvous duration 420. The rendezvous occasions 430 may occur at a fixed or variable rendezvous periodicity 410. The timing of the rendezvous occasions 430 may be synchronized between the UE and the BS such that the UE and the BS are both in a wake state during the rendezvous occasions 430. In some aspects, the UE may transmit a rendezvous occasion 430 schedule including a rendezvous duration 420 and periodicity 410 to the BS.

In some aspects, the UE may wakeup from the sleep state after the energy harvesting duration 450 and the rendezvous occasions 430 may begin again shifted in time from when the UE wakes up from the energy harvesting. For example, if the next rendezvous occasion 430 is scheduled for slot index 10 and the energy harvesting duration 450 occurs for 6 slots, the next rendezvous occasion 430 may begin at slot index 16. As shown in FIG. 5 the rendezvous occasions 430 may begin again after the energy harvesting duration 450 at new rendezvous duration start time 510.

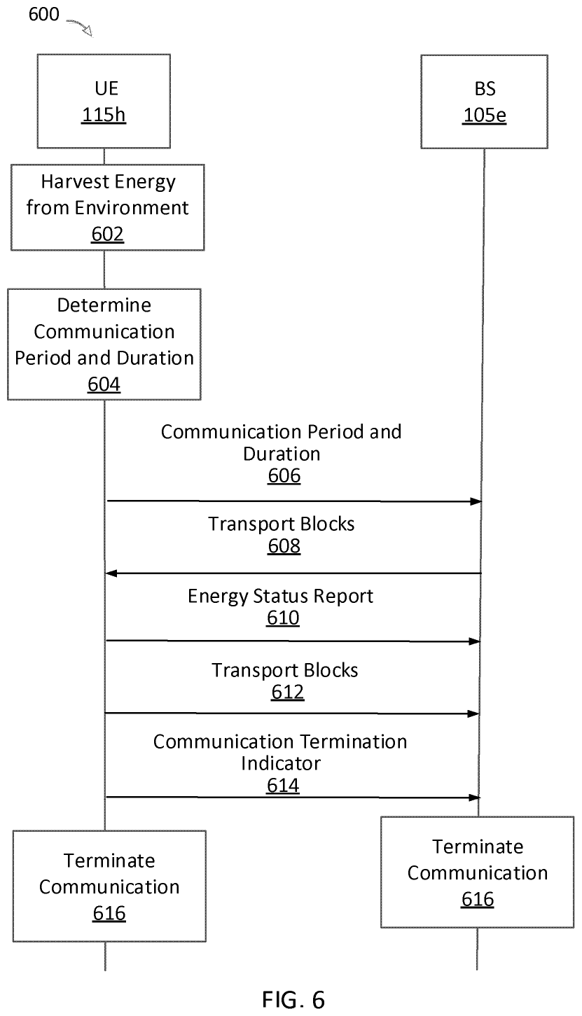

FIG. 6 is a signaling diagram of a communication method 600 according to some aspects of the present disclosure. Actions of the communication method 600 can be executed by a computing device (e.g., a processor, processing circuit, and/or other suitable component) of a communication device or other suitable means for performing the actions. For example, a wireless communication device, such as the UE 115h or UE 800, may utilize one or more components, such as the processor 802, the memory 804, the communication opportunity module 808, the energy harvesting module 809, the transceiver 810, the modem 812, and the one or more antennas 816, to execute aspects of method 600. For example, a wireless communication device, such as the BS 105e or BS 900, may utilize one or more components, such as the processor 902, the memory 904, the communication opportunity module 908, the energy harvesting module 909, the transceiver 910, the modem 912, and the one or more antennas 916, to execute aspects of communication method 600.

At action 602, the UE 115h may harvest energy from the ambient environment. In this regard, the UE 115h may harvest energy from the ambient environment using any suitable method. For example, the UE 115h may harvest (e.g., derive) energy from external sources to provide power (e.g., operating power) to the UE 115h. The UE 115h may harvest energy from a light source (e.g., solar radiation, photovoltaic cells, artificial light sources, etc.), an electromagnetic energy source (e.g., cellular communications, WiFi communications, NFC/RFID communications, magnetic induction, 50/60 Hz line radiation, etc.), a kinetic energy source (e.g., mechanical vibration, touchscreen press, piezoelectric source, UE 115h motion, wearable device motion, etc.), a thermoelectric source (e.g., user body heat, IoT device heat, ambient environment heat, etc.). In some aspects, the energy harvested from the ambient environment may be stored in the UE 115h. For example, the harvested energy may be stored in one or more batteries, capacitors, and/or other suitable storage devices. In some aspects, the UE 115h may not have an energy storage device and the energy harvested from the ambient environment may be used by the UE 115h as the energy is harvested.

At action 604, the UE 115h may determine a communication periodicity and a communication duration. In some aspects, the communication periodicity may be based on the energy harvesting. For example, the communication periodicity or the amount of time between each communication periodicity may be based on how much energy the UE 115h harvested during a previous time period and/or an estimate of how much energy the UE 115h will harvest during a future time period. Additionally or alternatively, the communication duration may be based on the energy harvesting. For example, the communication duration or the amount of time the UE 115h is in a wake state during each communication periodicity may be based on how much energy the UE 115h harvested during a previous time period, how much harvested energy is stored in the UE 115h, and/or an estimate of how much energy the UE 115h will harvest during a future time period. The UE 115h may communicate with the BS 105e and/or directly with other UEs via sidelink communications when the UE 115h is in the wake state during the communication duration. In some aspects, the indication of the communication periodicity and/or the communication duration may include a time value (e.g., a number of ms), a multiple or a fraction of a frame, a subframe, a slot, a sub-slot, a TTI, or a symbol. In some aspects, the indication of the communication periodicity and/or the communication duration may include a bitmap and/or a codepoint corresponding to a time value. The communication opportunity may include a plurality of communication opportunities occurring at a frequency based on the communication periodicity.

At action 606, the UE 115h may transmit a communication indicating the communication periodicity and a communication duration to the BS 105e. In this regard, the UE 115h may transmit the communication associated with the communication opportunity to the BS 105e via a physical uplink control channel (PUCCH), a physical uplink shared channel (PUSCH), uplink control information (UCI), or other suitable communication.

At action 608, the BS 105e may transmit one or more transport blocks (TBs) to the UE 115h. In this regard, the BS 105e may transmit one or more TBs to the UE 115h via a PDSCH during the communication opportunity.

At action 610, the UE 115h may transmit information to the BS 105e to assist in scheduling the communication periodicity and/or communication duration. For example, the UE 115h may transmit an energy status report to the BS 105e indicating the percent energy remaining in the UE 115h. In some instances, the energy status report may be based on a power consumption model as described above. In this regard, the UE 115h may transmit the energy status report to the BS 105e via a MAC CE message or other suitable communication.

Additionally or alternatively, the UE 115h may transmit UE 115h assistance information to the BS 105e to assist in scheduling the communication periodicity and/or communication duration. In this regard, the UE 115h may transmit the UE 115h assistance information via an RRC message, UCI, an UL MAC CE, or other suitable communication. The UE 115h assistance information may include, without limitation, a bandwidth part for communication, a frequency band, a subcarrier spacing (SCS), a modulation and coding scheme (MCS), a maximum TB size, and/or a minimum TB size. In some aspects, the UE 115h may transmit the UE assistance information when the UE assistance information prohibit timer is not running. The UE assistance information prohibit timer may be a timer that indicates when the UE 115h may transmit the UE assistance information. In some aspects, the BS 105e may transmit an indicator to the UE 115h that configures the UE assistance information prohibit timer. The BS 105e may transmit an indicator to the UE 115h that indicates when the UE assistance information prohibit timer shall start (e.g., timer running) and stop (e.g., timer not running). The UE 115h may refrain from transmitting the UE assistance information to the BS 105e when the UE assistance information prohibit timer is running.

At action 612, the UE 115h may transmit one or more TBs to the BS 105e. In this regard, the UE 115h may transmit one or more TBs to the BS 105e via a PUSCH during the communication opportunity.

At action 614, the UE 115h may transmit a communication termination indicator to the BS 105e. In some aspects, the UE 115h may transmit the communication termination indicator to the BS 105e indicating an early termination of a communication duration. The UE 115h may transmit the communication termination indicator based on the UE 115h having transmitted all the data in the UE's buffer. Additionally or alternatively, the UE 115h may transmit the communication termination indicator based on the UE 115h having a low usable energy level (e.g., the stored and/or harvested energy is below a threshold) and/or other power parameters associated with the UE 115h. In this regard, the UE 115h may transmit the communication termination indicator in a PUCCH communication, a PUSCH communication, UCI, an UL DRX MAC CE, or other suitable communication. In some aspects, the communication termination indicator may be a codepoint (e.g., a single bit 0 or 1) indicating whether the communication duration should be terminated before the end of the scheduled communication duration. In some instances, the codepoint may be indicated via a PUCCH message and/or multiplexed with HARQ feedback to the BS 105e.

Additionally or alternatively, the termination indicator may be an indication (e.g., an explicit indication) of when the communication duration should terminate (e.g., a time to when the UE 115h enters a sleep state). The termination indicator may be an amount of time from the start of the communication duration, an amount of time from the end of the communication duration, a delta amount of time from a previous termination indicator, or other suitable termination indicator. In some aspects, the termination indicator may include a time value (e.g., a number of ms), a multiple or a fraction of a frame, a multiple or a fraction of a subframe, a multiple or a fraction of a slot, a multiple or a fraction of a sub-slot, a multiple or a fraction of a TTI, or a multiple or a fraction of a symbol. In some aspects, the indication of the termination indicator may include a bitmap and/or a codepoint corresponding to a time value.

At action 616, the UE 115h and the BS 105e may terminate communications based on the termination indicator at action 614. In some aspects, the UE 115h may enter a sleep state after terminating communications with the BS 105e. The UE 115h may wakeup from the sleep state at the beginning of the next communication duration. The BS 105e may wakeup from the sleep state at the beginning of the next communication duration.

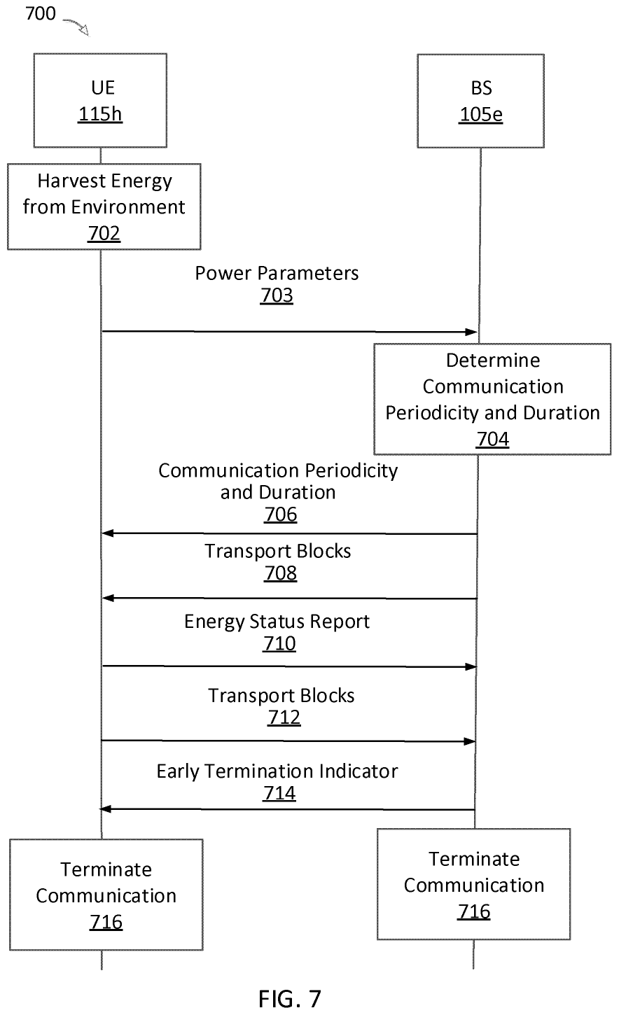

FIG. 7 is a signaling diagram of a communication method 700 according to some aspects of the present disclosure. Actions of the communication method 700 can be executed by a computing device (e.g., a processor, processing circuit, and/or other suitable component) of a communication device or other suitable means for performing the actions. For example, a wireless communication device, such as the UE 115h or UE 800, may utilize one or more components, such as the processor 802, the memory 804, the communication opportunity module 808, the energy harvesting module 809, the transceiver 810, the modem 812, and the one or more antennas 816, to execute aspects of method 700. For example, a wireless communication device, such as the BS 105e or BS 900, may utilize one or more components, such as the processor 902, the memory 904, the communication opportunity module 908, the energy harvesting module 909, the transceiver 910, the modem 912, and the one or more antennas 916, to execute aspects of communication method 700.

At action 702, the UE 115h may harvest energy from the ambient environment. In this regard, the UE 115h may harvest energy from the ambient environment using any suitable method. For example, the UE 115h may harvest (e.g., derive) energy from external sources to provide power (e.g., operating power) to the UE 115h. The UE 115h may harvest energy from a light source (e.g., solar radiation, photovoltaic cells, artificial light sources, etc.), an electromagnetic energy source (e.g., cellular communications, WiFi communications, NFC/RFID communications, magnetic induction, 50/60 Hz line radiation, etc.), a kinetic energy source (e.g., mechanical vibration, touchscreen press, piezoelectric source, UE 115h motion, wearable device motion, etc.), a thermoelectric source (e.g., user body heat, IoT device heat, ambient environment heat, etc.). In some aspects, the energy harvested from the ambient environment may be stored in the UE 115h. For example, the harvested energy may be stored in one or more batteries, capacitors, and/or other suitable storage devices. In some aspects, the UE 115h may not have an energy storage device and the energy harvested from the ambient environment may be used by the UE 115h as the energy is harvested.

At action 704, the UE 115h may transmit power parameters to the BS 105. In method 600 above, the UE 115h may determine the communication periodicity and duration. In method 700, the UE 115h transmits the power parameters to the BS 105e and the BS 105e determines the communication periodicity and duration based on the power parameters. The UE 115h may transmit power parameters including energy harvesting parameters, energy storage parameters, and/or power consumption parameters to the BS 105e via a PUCCH, a PUSCH, UCI, an RRC message, a MAC-CE message, or other suitable communication. The UE 115h may transmit (e.g., transmit periodically and/or aperiodically) the power consumption parameters to the BS 105e including, without limitation, a percent of usable energy that an empty slot may consume (e.g., energy consumed by the UE during a slot when the UE is in an RRC connected state but not receiving or transmitting data), an amount of energy consumed by the UE during reception of a PDCCH communication, an amount of energy consumed by the UE during reception of a PDSCH communication (e.g., reception of a PDSCH carrying a minimum size TB), an amount of energy consumed by the UE during transmission of a PUCCH communication, and/or an amount of energy consumed by the UE during transmission of a PUSCH communication (e.g., transmission of a PUSCH carrying a minimum size TB).

As an alternative to reporting the power consumption parameters to the BS 105e as a percent of usable energy, the UE 115h may transmit (e.g., transmit periodically and/or aperiodically) the power consumption parameters as multiples of a base power level. The base power level may be the energy (e.g., a number of joules and/or a percent of the UE's usable amount of energy) that an empty slot may consume (e.g., energy consumed by the UE 115h during a slot when the UE 115h is in an RRC connected state but not receiving or transmitting data). The UE 115h may report the base power level, a multiplier of the base power level indicating an amount of energy consumed by the UE 115h during reception of a PDCCH communication, a multiplier of the base power level indicating an amount of energy consumed by the UE 115h during reception of a PDSCH communication (e.g., reception of a PDSCH carrying a minimum size TB), a multiplier of the base power level indicating an amount of energy consumed by the UE 115h during transmission of a PUCCH communication, and/or a multiplier of the base power level indicating an amount of energy consumed by the UE 115h during transmission of a PUSCH communication (e.g., transmission of a PUSCH carrying a minimum size TB).

At action 704, the BS 105e may determine the communication duration and/or the communication periodicity using a power consumption model that considers the power parameters received from the UE 115h at action 703. The power consumption model may consider, without limitation, the energy harvesting capacity of the UE 115h, the energy storage capacity of the UE 115h, the amount of data to be communicated, and the UE 115h power consumption parameters associated with the communications. In some aspects, the communication periodicity and/or the communication duration may be scheduled by the BS 105e on a semi-persistent basis. The BS 105e may update the communication periodicity and/or the communication duration schedule based on operating conditions and/or an amount of data to be communicated with the UE 115h. The UE 115h may request an updated communication periodicity and/or communication duration from the BS 105e via a UE assistance information message and/or a MAC CE message. The UE 115h may transmit updated energy harvesting parameters and/or a buffer status report (BSR) to the BS 105e. The BSR may indicate an amount of data to be transmitted by the UE 115h. In response, the BS 105e may transmit an updated communication periodicity and/or the communication duration schedule to the UE 115h. The communication periodicity and/or the communication duration may be updated on a periodic and/or aperiodic basis. In some aspects, the indication of an updated communication periodicity and/or communication duration may include a change field (e.g., a codepoint) where “0” indicates no change in the communication periodicity and/or communication duration and “1” indicates a change in the communication periodicity and/or communication duration. If the change field is set to “1”, the BS 105e may transmit the updated communication periodicity and/or communication duration to the UE 115h in addition to the change field. For example, when the harvested energy, the stored energy, or the amount of TBs to be communicated increases, the BS 105e may decrease the communication periodicity and/or increase the communication duration. When the harvested energy, the stored energy, or the amount of TBs to be communicated decrease, the BS 105e may increase the communication periodicity and/or decrease the communication duration.

At action 706, the BS 105e may transmit the communication duration and/or the communication periodicity to the UE 115h via a PDCCH, a PDSCH, DCI, an RRC message, a MAC-CE message, or other suitable communication.

At action 708, the BS 105e may transmit one or more TBs to the UE 115h. In this regard, the BS 105e may transmit one or more TBs to the UE 115h via a PDSCH during the communication opportunity.

At action 710, the UE 115h may transmit information to the BS 105e to assist the BS 105e in scheduling the communication periodicity and/or communication duration. For example, the UE 115h may transmit an energy status report to the BS 105e indicating the percent energy remaining in the UE 115h. In some instances, the energy status report may be based on a power consumption model as described above. In this regard, the UE 115h may transmit the energy status report to the BS 105e via a MAC CE message or other suitable communication.

Additionally or alternatively, the UE 115h may transmit UE assistance information to the BS 105e to assist the BS 105e in scheduling the communication periodicity and/or communication duration. In this regard, the UE 115h may transmit the UE assistance information via an RRC message, UCI, an UL MAC CE, or other suitable communication. The UE assistance information may include, without limitation, a bandwidth part for communication, a frequency band, a subcarrier spacing (SCS), a modulation and coding scheme (MCS), a maximum TB size, and/or a minimum TB size. In some aspects, the UE 115h may transmit the UE assistance information when the UE assistance information prohibit timer is not running. The UE assistance information prohibit timer may be a timer that indicates when the UE 115h may transmit the UE assistance information. In some aspects, the BS 105e may transmit an indicator to the UE 115h that configures the UE assistance information prohibit timer. The BS 105e may transmit an indicator to the UE 115h that indicates when the UE assistance information prohibit timer shall start (e.g., timer running) and stop (e.g., timer not running). The UE 115h may refrain from transmitting the UE assistance information to the BS 105e when the UE assistance information prohibit timer is running.

At action 712, the UE 115h may transmit one or more TBs to the BS 105e. In this regard, the UE 115h may transmit one or more TBs to the BS 105e via a PUSCH during the communication opportunity.

At action 714, the BS 105e may transmit a communication termination indicator to the UE 115h. In some aspects, the BS 105e may transmit the communication termination indicator to the UE 115h indicating an early termination of a communication duration. The BS 105e may transmit the communication termination indicator based on the BS 105e having transmitted all the data in the BS's buffer. Additionally or alternatively, in the case where the BS 105e is an energy harvesting BS, the BS 105e may transmit the communication termination indicator based on the BS 105e having a low usable energy level (e.g., the stored and/or harvested energy is below a threshold) and/or other power parameters associated with the BS 105e. In this regard, the BS 105e may transmit the communication termination indicator in a PDCCH communication, a PDSCH communication, DCI, a DL DRX MAC CE, or other suitable communication. In some aspects, the communication termination indicator may be a codepoint (e.g., a single bit “0” or “1”) indicating whether the communication duration should be terminated before the end of the scheduled communication duration. In some instances, the codepoint may be indicated via a PDCCH message. Additionally or alternatively, the termination indicator may be an indication (e.g., an explicit indication) of when the communication duration should terminate (e.g., a time to when the UE 115h and/or the BS 105e enters a sleep state). The termination indicator may be an amount of time from the start of the communication duration, an amount of time from the end of the communication duration, a delta amount of time from a previous termination indicator, or other suitable termination indicator. In some aspects, the termination indicator may include a time value (e.g., a number of ms), a multiple or a fraction of a frame, a multiple or a fraction of a subframe, a multiple or a fraction of a slot, a multiple or a fraction of a sub-slot, a multiple or a fraction of a TTI, or a multiple or a fraction of a symbol. In some aspects, the indication of the termination indicator may include a bitmap and/or a codepoint corresponding to a time value.

At action 716, the UE 115h and the BS 105e may terminate communications based on the termination indicator at action 714. In some aspects, the UE 115h may enter a sleep state after terminating communications with the BS 105e. The UE 115h may wakeup from the sleep state at the beginning of the next communication duration. Additionally or alternatively, the UE BS 105e may enter a sleep state after terminating communications with the UE 115h. The BS 105e may wakeup from the sleep state at the beginning of the next communication duration.

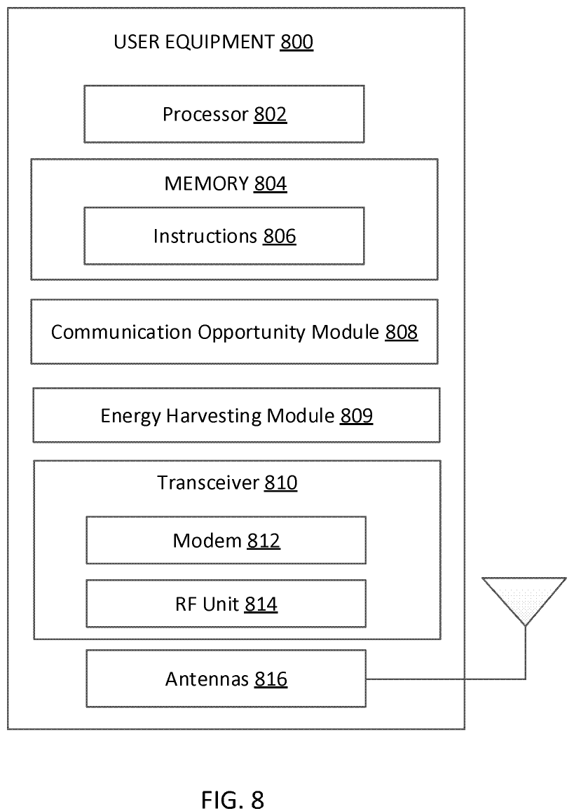

FIG. 8 is a block diagram of an exemplary UE 800 according to some aspects of the present disclosure. The UE 800 may be the UE 115 in the network 100 or 200 as discussed above. As shown, the UE 800 may include a processor 802, a memory 804, a communication opportunity module 808, an energy harvesting module 809, a transceiver 810 including a modem subsystem 812 and a radio frequency (RF) unit 814, and one or more antennas 816. These elements may be coupled with each other and in direct or indirect communication with each other, for example via one or more buses.

The processor 802 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 802 may also be implemented as a combination of computing devices, e.g., a combination of a DSP and a microprocessor, a plurality of microprocessors, one or more microprocessors in conjunction with a DSP core, or any other such configuration.

The memory 804 may include a cache memory (e.g., a cache memory of the processor 802), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 804 includes a non-transitory computer-readable medium. The memory 804 may store instructions 806. The instructions 806 may include instructions that, when executed by the processor 802, cause the processor 802 to perform the operations described herein with reference to the UEs 115 in connection with aspects of the present disclosure, for example, aspects of FIGS. 2-7 and 10-11. Instructions 806 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication opportunity module 808 and the energy harvesting module 809 may be implemented via hardware, software, or combinations thereof. For example, the communication opportunity module 808 and the energy harvesting module 809 may be implemented as a processor, circuit, and/or instructions 806 stored in the memory 804 and executed by the processor 802.

In some aspects, the energy harvesting module 809 may harvest energy from an ambient environment associated with the UE 800. The communication opportunity module 808 may transmit a communication to the BS (e.g., the BS 105 or the BS 900) associated with a communication opportunity. The communication opportunity may be based on parameters associated with the harvesting of the energy from the ambient environment. Aspects of the present disclosure may overcome the challenges of limited energy availability in the UE 800 by using methods for coordinating communication between the energy harvesting UE 800 and the BS. In this regard, the energy harvested by the UE 800 using the energy harvesting module 809 may be used to communicate with the BS using the communication opportunity module 808.

As shown, the transceiver 810 may include the modem subsystem 812 and the RF unit 814. The transceiver 810 can be configured to communicate bi-directionally with other devices, such as the BSs 105 and/or the UEs 115. The modem subsystem 812 may be configured to modulate and/or encode the data from the memory 804 and the cooperative paging and WUS module 808 according to a modulation and coding scheme (MCS), e.g., a low-density parity check (LDPC) coding scheme, a turbo coding scheme, a convolutional coding scheme, a digital beamforming scheme, etc. The RF unit 814 may be configured to process (e.g., perform analog to digital conversion or digital to analog conversion, etc.) modulated/encoded data from the modem subsystem 812 (on outbound transmissions) or of transmissions originating from another source such as a UE 115 or a BS 105. The RF unit 814 may be further configured to perform analog beamforming in conjunction with the digital beamforming. Although shown as integrated together in transceiver 810, the modem subsystem 812 and the RF unit 814 may be separate devices that are coupled together to enable the UE 800 to communicate with other devices.

The RF unit 814 may provide the modulated and/or processed data, e.g. data packets (or, more generally, data messages that may contain one or more data packets and other information), to the antennas 816 for transmission to one or more other devices. The antennas 816 may further receive data messages transmitted from other devices. The antennas 816 may provide the received data messages for processing and/or demodulation at the transceiver 810. The antennas 816 may include multiple antennas of similar or different designs in order to sustain multiple transmission links. The RF unit 814 may configure the antennas 816.

In some instances, the UE 800 can include multiple transceivers 810 implementing different RATs (e.g., NR and LTE). In some instances, the UE 800 can include a single transceiver 810 implementing multiple RATs (e.g., NR and LTE). In some instances, the transceiver 810 can include various components, where different combinations of components can implement RATs.

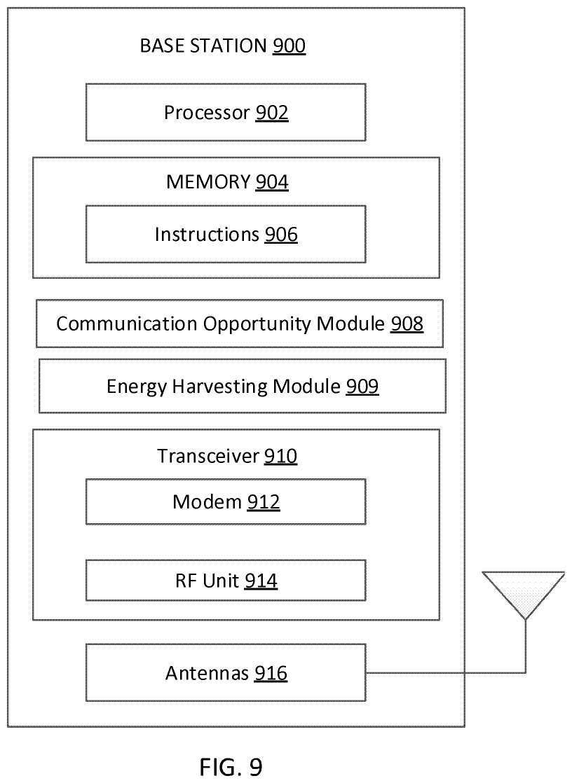

FIG. 9 is a block diagram of an exemplary BS 900 according to some aspects of the present disclosure. The BS 900 may be a BS 105 as discussed above. As shown, the BS 900 may include a processor 902, a memory 904, a communication opportunity module 908, an energy harvesting module 909, a transceiver 910 including a modem subsystem 912 and a RF unit 914, and one or more antennas 916. These elements may be coupled with each other and in direct or indirect communication with each other, for example via one or more buses.

The processor 902 may have various features as a specific-type processor. For example, these may include a CPU, a DSP, an ASIC, a controller, a FPGA device, another hardware device, a firmware device, or any combination thereof configured to perform the operations described herein. The processor 902 may also be implemented as a combination of computing devices, e.g., a combination of a DSP and a microprocessor, a plurality of microprocessors, one or more microprocessors in conjunction with a DSP core, or any other such configuration.

The memory 904 may include a cache memory (e.g., a cache memory of the processor 902), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 904 may include a non-transitory computer-readable medium. The memory 904 may store instructions 906. The instructions 906 may include instructions that, when executed by the processor 902, cause the processor 902 to perform operations described herein, for example, aspects of FIGS. 2-7 and 10-11. Instructions 906 may also be referred to as code, which may be interpreted broadly to include any type of computer-readable statement(s).

The communication opportunity module 908 and the energy harvesting module 909 may be implemented via hardware, software, or combinations thereof. For example, the communication opportunity module 908 and the energy harvesting module 909 may be implemented as a processor, circuit, and/or instructions 906 stored in the memory 904 and executed by the processor 902.

In some aspects, the communication opportunity module 908 may receive a communication from a UE (e.g., the UE 115 or the UE 800) associated with a communication opportunity. The communication opportunity may be based on parameters associated with energy harvesting by the UE. In some aspects, the energy harvesting module 909 may harvest energy from an ambient environment associated with the BS 900. The communication opportunity module 908 may transmit one or more TBs to the UE based on the communication opportunity. Aspects of the present disclosure may overcome the challenges of limited energy availability in the UE or the BS 900 by using methods for coordinating communication between the energy harvesting UE and the BS 900. In this regard, the energy harvested by the UE may be used to communicate with the BS 900 using the communication opportunity module 908.

Additionally or alternatively, the communication opportunity module 908 and the energy harvesting module 909 can be implemented in any combination of hardware and software, and may, in some implementations, involve, for example, processor 902, memory 904, instructions 906, transceiver 910, and/or modem 912.

As shown, the transceiver 910 may include the modem subsystem 912 and the RF unit 914. The transceiver 910 can be configured to communicate bi-directionally with other devices, such as the UEs 115 and/or 600. The modem subsystem 912 may be configured to modulate and/or encode data according to a MCS, e.g., a LDPC coding scheme, a turbo coding scheme, a convolutional coding scheme, a digital beamforming scheme, etc. The RF unit 914 may be configured to process (e.g., perform analog to digital conversion or digital to analog conversion, etc.) modulated/encoded data from the modem subsystem 912 (on outbound transmissions) or of transmissions originating from another source such as a UE 115 or UE 800. The RF unit 914 may be further configured to perform analog beamforming in conjunction with the digital beamforming. Although shown as integrated together in transceiver 910, the modem subsystem 912 and/or the RF unit 914 may be separate devices that are coupled together at the BS 900 to enable the BS 900 to communicate with other devices.

The RF unit 914 may provide the modulated and/or processed data, e.g. data packets (or, more generally, data messages that may contain one or more data packets and other information), to the antennas 916 for transmission to one or more other devices. This may include, for example, a configuration indicating a plurality of sub-slots within a slot according to aspects of the present disclosure. The antennas 916 may further receive data messages transmitted from other devices and provide the received data messages for processing and/or demodulation at the transceiver 910. The antennas 916 may include multiple antennas of similar or different designs in order to sustain multiple transmission links.

In some instances, the BS 900 can include multiple transceivers 910 implementing different RATs (e.g., NR and LTE). In some instances, the BS 900 can include a single transceiver 910 implementing multiple RATs (e.g., NR and LTE). In some instances, the transceiver 910 can include various components, where different combinations of components can implement RATs.

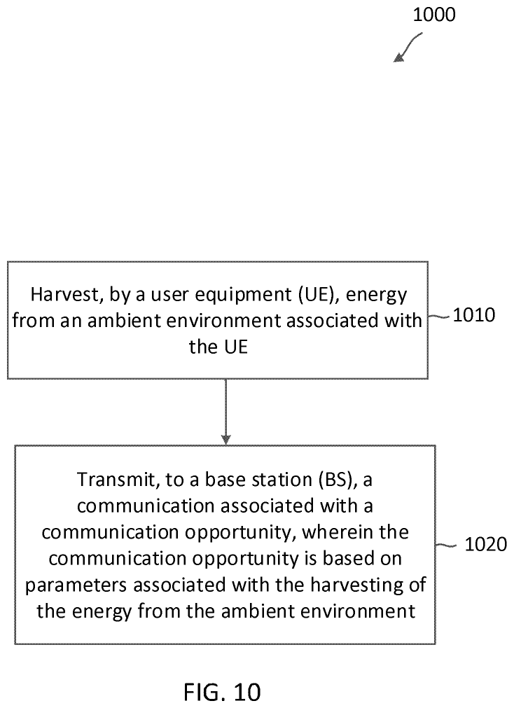

FIG. 10 is a flow diagram of a communication method 1000 according to some aspects of the present disclosure. Aspects of the method 1000 can be executed by a computing device (e.g., a processor, processing circuit, and/or other suitable component) of a wireless communication device or other suitable means for performing the aspects. For example, a wireless communication device, such as the UE 115 or UE 800, may utilize one or more components, such as the processor 802, the memory 804, the communication opportunity module 808, the energy harvesting module 809, the transceiver 810, the modem 812, and the one or more antennas 816, to execute aspects of method 1000. The method 1000 may employ similar mechanisms as in the networks 100 and 200 and the aspects and actions described with respect to FIGS. 2-7. As illustrated, the method 1000 includes a number of enumerated aspects, but the method 1000 may include additional aspects before, after, and in between the enumerated aspects. In some aspects, one or more of the enumerated aspects may be omitted or performed in a different order.

At 1010, the method 1000 includes a UE (e.g., the UE 115 or the UE 800) harvesting energy from an ambient environment associated with the UE. In this regard, the UE may harvest energy from the ambient environment using any suitable method. For example, the UE may harvest (e.g., derive) energy from external sources to provide power (e.g., operating power) to the UE. The UE may harvest energy from a light source (e.g., solar radiation, photovoltaic cells, artificial light sources, etc.), an electromagnetic energy source (e.g., cellular communications, WiFi communications, NFC/RFID communications, magnetic induction, 50/60 Hz line radiation, etc.), a kinetic energy source (e.g., mechanical vibration, touchscreen press, piezoelectric source, UE motion, wearable device motion, etc.), a thermoelectric source (e.g., user body heat, IoT device heat, ambient environment heat, etc.). In some aspects, the energy harvested from the ambient environment may be stored in the UE. For example, the harvested energy may be stored in one or more batteries, capacitors, and/or other suitable storage devices. In some aspects, the UE may not have an energy storage device and the energy harvested from the ambient environment may be used by the UE as the energy is harvested. The amount of energy available to the UE for communications and/or other actions may be limited by the energy storage capacity, the amount of energy available in the ambient environment, and/or the energy harvesting method. Aspects of the present disclosure may overcome the challenges of limited energy availability in the UE using methods for coordinating communication between energy harvesting UEs and a BS. In this regard, the energy harvested by the UE may be used to communicate with a BS (e.g., the BS 105 or the BS 900).

At 1020, the method 1000 includes a UE (e.g., the UE 115 or the UE 800) transmitting a communication associated with a communication opportunity to a base station (BS) (e.g., the BS 105 or the BS 900). The communication opportunity may be based on parameters associated with the energy harvested by the UE from the ambient environment at 1010. In this regard, the UE may transmit the communication associated with the communication opportunity to the BS via a physical uplink control channel (PUCCH), a physical uplink shared channel (PUSCH), uplink control information (UCI), or other suitable communication.

In some aspects, the communication associated with the communication opportunity may include an indication of a communication periodicity and/or an indication of a communication duration. In some instances, the UE may wakeup from a low power mode (e.g., a sleep mode) to communicate with the BS based on the communication periodicity. The communication periodicity may define a communication periodicity having a start and/or an end. In some instances, the UE may wakeup at the start and/or offset from the start of the communication period. In some aspects, the communication periodicity may be based on the energy harvesting. For example, the communication periodicity or the amount of time between each communication periodicity may be based on how much energy the UE harvested during a previous time period and/or an estimate of how much energy the UE will harvest during a future time period. Additionally or alternatively, the communication duration may be based on the energy harvesting. For example, the communication duration or the amount of time the UE is in a wake state during each communication periodicity may be based on how much energy the UE harvested during a previous time period, how much harvested energy is stored in the UE, and/or an estimate of how much energy the UE will harvest during a future time period. The UE may communicate with the BS and/or directly with other UEs via sidelink communications when the UE is in the wake state during the communication duration. The communication opportunity may include a plurality of communication opportunities occurring at a frequency based on the communication periodicity.

The UE may transmit communications to the BS and/or receive communications from the BS during the communication opportunity. The UE may transmit one or more transport blocks (TBs) to the BS via a PUSCH during the communication opportunity. The UE may receive one or more TBs from the BS via a PDSCH during the communication opportunity.

In some aspects, the UE may determine the communication periodicity and/or the communication duration. The UE may transmit an indication of the communication periodicity and/or the communication duration to the BS via a PUCCH, a PUSCH, UCI, an RRC message, a MAC-CE message, or other suitable communication. In some aspects, the indication of the communication periodicity and/or the communication duration may include a time value (e.g., a number of ms), a multiple or a fraction of a frame, a multiple or a fraction of a subframe, a multiple or a fraction of a slot, a multiple or a fraction of a sub-slot, a multiple or a fraction of a TTI, or a multiple or a fraction of a symbol. In some aspects, the indication of the communication periodicity and/or the communication duration may include a bitmap and/or a codepoint corresponding to a time value. The UE may determine the communication periodicity and/or the communication duration using any suitable method. For example, the UE may determine the communication periodicity and/or the communication duration based on the energy harvesting capabilities of the UE and/or the energy storage capabilities of the UE. A UE with a higher energy harvesting capability and/or energy storage capability may have a shorter communication periodicity and/or a longer communication duration compared to a UE having a lower energy harvesting capability and/or energy storage capability. In some aspects, the UE may determine the communication periodicity and/or the communication duration based on a scheduled and/or estimated amount of data/control communications and the amount of energy required for the data/control communications. For example, the UE may be an IoT device scheduled to transmit/receive a number of TBs during a time frame. The UE may determine the communication periodicity and/or the communication duration based on an estimated amount of energy required to transmit and/or receive the TBs (e.g., joules per bit of data). In some aspects, the communication periodicity and/or the communication duration may be scheduled by the UE on a semi-persistent basis. The UE may update the communication periodicity and/or the communication duration schedule based on operating conditions, energy harvesting, and/or the amount of data to be communicated. The UE may transmit an indication of an updated communication periodicity and/or communication duration to the BS on a periodic and/or aperiodic basis. In some aspects, the indication of an updated communication periodicity and/or communication duration may include a change field (e.g., a codepoint) where “0” indicates no change in the communication periodicity and/or communication duration and “1” indicates a change in the communication periodicity and/or communication duration. If the change field is set to “1”, the UE may transmit the updated communication periodicity and/or communication duration in addition to the change field. For example, when the harvested energy, the stored energy, and/or the amount of TBs to be communicated increases, the UE may decrease the communication periodicity (e.g., increasing the frequency of communication) and/or increase the communication duration. When the harvested energy, the stored energy, and/or the amount of TBs to be communicated decreases, the UE may increase the communication periodicity (e.g., decreasing the frequency of communication) and/or decrease the communication duration.

Additionally or alternatively, the communication associated with the communication opportunity may include an indication of a communication periodicity and an indication of a communication duty cycle. The communication duty cycle may be indicated as a percent and/or a fraction of the communication period. For example, the communication duty cycle may be a communication duration divided by the communication period.

Additionally or alternatively, the BS may determine the communication duration and/or the communication period. In this regard, the UE may transmit energy harvesting parameters, energy storage parameters, and/or power consumption parameters to the BS via a PUCCH, a PUSCH, UCI, an RRC message, a MAC-CE message, or other suitable communication. In some aspects, the indication of the communication periodicity and/or the communication duration may include a time value (e.g., a number of ms), a multiple or a fraction of a frame, a subframe, a slot, a sub-slot, a TTI, or a symbol. In some aspects, the indication of the communication periodicity and/or the communication duration may include a bitmap and/or a codepoint corresponding to a time value. In response, the BS may determine the communication duration and/or the communication periodicity and transmit the communication duration and/or the communication periodicity to the UE via a PDCCH, a PDSCH, DCI, an RRC message, a MAC-CE message, or other suitable communication. For example, the BS may determine the communication duration and/or the communication periodicity using a power consumption model that considers, without limitation, the energy harvesting capacity of the UE, the energy storage capacity of the UE, the amount of data to be communicated, and the UE power consumption parameters associated with the communications. The UE may report (e.g., report periodically and/or aperiodically) the power consumption parameters to the BS including, without limitation, a percent of usable energy that an empty slot may consume (e.g., energy consumed by the UE during a slot when the UE is in an RRC connected state but not receiving or transmitting data), an amount of energy consumed by the UE during reception of a PDCCH communication, an amount of energy consumed by the UE during reception of a PDSCH communication (e.g., reception of a PDSCH carrying a minimum size TB), an amount of energy consumed by the UE during transmission of a PUCCH communication, and/or an amount of energy consumed by the UE during transmission of a PUSCH communication (e.g., transmission of a PUSCH carrying a minimum size TB). In some aspects, the communication periodicity and/or the communication duration may be scheduled by the BS on a semi-persistent basis. The BS may update the communication periodicity and/or the communication duration schedule based on operating conditions and/or an amount of data to be communicated with the UE. The UE may request an updated communication periodicity and/or communication duration from the BS via a UE assistance information message and/or a MAC CE message. The UE may transmit updated energy harvesting parameters and/or a buffer status report (BSR) to the BS. The BSR may indicate an amount of data to be transmitted by the UE. In response, the BS may transmit an updated communication periodicity and/or the communication duration schedule to the UE. The communication periodicity and/or the communication duration may be updated on a periodic and/or aperiodic basis. In some aspects, the indication of an updated communication periodicity and/or communication duration may include a change field (e.g., a codepoint) where “0” indicates no change in the communication periodicity and/or communication duration and “1” indicates a change in the communication periodicity and/or communication duration. If the change field is set to “1”, the BS may transmit the updated communication periodicity and/or communication duration to the UE in addition to the change field. For example, when the harvested energy, the stored energy, or the amount of TBs to be communicated increases, the BS may decrease the communication periodicity and/or increase the communication duration. When the harvested energy, the stored energy, or the amount of TBs to be communicated decrease, the BS may increase the communication periodicity and/or decrease the communication duration.

As an alternative to reporting the power consumption parameters to the BS as a percent of usable energy, the UE may report (e.g., report periodically and/or aperiodically) the power consumption parameters as multiples of a base power level. The base power level may be the energy (e.g., a number of joules and/or a percent of the UE's usable amount of energy) that an empty slot may consume (e.g., energy consumed by the UE during a slot when the UE is in an RRC connected state but not receiving or transmitting data). The UE may report the base power level, a multiplier of the base power level indicating an amount of energy consumed by the UE during reception of a PDCCH communication, a multiplier of the base power level indicating an amount of energy consumed by the UE during reception of a PDSCH communication (e.g., reception of a PDSCH carrying a minimum size TB), a multiplier of the base power level indicating an amount of energy consumed by the UE during transmission of a PUCCH communication, and/or a multiplier of the base power level indicating an amount of energy consumed by the UE during transmission of a PUSCH communication (e.g., transmission of a PUSCH carrying a minimum size TB).

In some aspects, the UE may transmit an indicator to the BS indicating an early termination of a communication duration. The UE may transmit the communication termination indicator based on the UE having transmitted all the data in the UE's buffer. Additionally or alternatively, the UE may transmit the communication termination indicator based on the UE having a low usable energy level (e.g., the stored and/or harvested energy is below a threshold) and/or other power parameters associated with the UE. In this regard, the UE may transmit the communication termination indicator in a PUCCH communication, a PUSCH communication, UCI, an UL DRX MAC CE, or other suitable communication. In some aspects, the communication termination indicator may be a codepoint (e.g., a single bit 0 or 1) indicating whether the communication duration should be terminated before the end of the scheduled communication duration. In some instances, the codepoint may be indicated via a PUCCH message and/or multiplexed with HARQ feedback to the BS. Additionally or alternatively, the termination indicator may be an indication (e.g., an explicit indication) of when the communication duration should terminate (e.g., a time to when the UE enters a sleep state). The termination indicator may be an amount of time from the start of the communication duration, an amount of time from the end of the communication duration, a delta amount of time from a previous termination indicator, or other suitable termination indicator. In some aspects, the termination indicator may include a time value (e.g., a number of ms), a multiple or a fraction of a frame, a multiple or a fraction of a subframe, a multiple or a fraction of a slot, a multiple or a fraction of a sub-slot, a multiple or a fraction of a TTI, or a multiple or a fraction of a symbol. In some aspects, the indication of the termination indicator may include a bitmap and/or a codepoint corresponding to a time value.

In some aspects, the BS may indicate an early termination of a communication duration. In this regard, the BS may indicate early termination of the communication duration via a DRX MAC CE message, a time to dormancy (TTD) MAC CE message, a MAC CE message, and/or DCI. In some aspects, the BS may transmit an indicator to the UE indicating when to terminate the communication (e.g., early termination) based on when the BS has no more data to transmit to the UE. The UE may enter a sleep state after receiving the communication duration termination indicator from the BS.

In some aspects, the UE may transmit information to the BS to assist the BS in scheduling the communication periodicity and/or communication duration. For example, the UE may transmit an energy status report to the BS indicating the percent energy remaining in the UE. In some instances, the energy status report may be based on a power consumption model as described above. In this regard, the UE may transmit the energy status report to the BS via a MAC CE message or other suitable communication.

Additionally or alternatively, the UE may transmit UE assistance information to the BS to assist the BS in scheduling the communication periodicity and/or communication duration. In this regard, the UE may transmit the UE assistance information via an RRC message, UCI, an UL MAC CE, or other suitable communication. The UE assistance information may include, without limitation, a bandwidth part for communication, a frequency band, a subcarrier spacing (SCS), a modulation and coding scheme (MCS), a maximum TB size, and/or a minimum TB size. In some aspects, the UE may transmit the UE assistance information when the UE assistance information prohibit timer is not running. The UE assistance information prohibit timer may be a timer that indicates when the UE may transmit the UE assistance information. In some aspects, the BS may transmit an indicator to the UE that configures the UE assistance information prohibit timer. The BS may transmit an indicator to the UE that indicates when the UE assistance information prohibit timer shall start (e.g., timer running) and stop (e.g., timer not running). The UE may refrain from transmitting the UE assistance information to the BS when the UE assistance information prohibit timer is running.

Additionally or alternatively, the BS and the UE may establish (e.g., preconfigure) a sequence of rendezvous occasions. The BS and UE may communicate with each other during the rendezvous occasions. Each rendezvous occasion may have a fixed or variable time duration. The rendezvous occasions may occur at a fixed or variable periodicity. The timing of the rendezvous occasions may be synchronized between the UE and the BS such that the UE and the BS are both in a wake state during the rendezvous occasions. In some aspects, the UE may transmit a rendezvous occasion schedule including a rendezvous duration and periodicity to the BS. In response, the BS may confirm the rendezvous occasion schedule or transmit a different rendezvous occasion schedule to the UE. In some aspects, when the UE and BS do not have data to communicate, the UE may enter a sleep state. For example, the UE may wake up during a rendezvous occasion and receive an indicator (e.g., a BSR) from the BS indicating the BS has no data to transmit to the UE. In response to the indicator indicating the BS has no data to transmit, the UE may enter a sleep state and remain in the sleep state until the next rendezvous occasion. In some aspects, when either the UE or the BS has data to communicate, the UE may wakeup during the rendezvous occasion and remain in a wake state until there is no more data to communicate and/or the energy associated with the UE has fallen below a threshold. In this case, the UE may wake up during the next rendezvous occasion when the energy associated with the UE has increased above a threshold. In some aspects, the UE may transmit an indicator to the BS indicating when the UE expects to have no more data to communicate or when the energy associated with the UE is expected to fall below the threshold.

In some aspects, the UE may enter or remain in a sleep state for a duration (e.g., a minimum duration) after the rendezvous occasion. The UE may enter or remain in a sleep state for the duration after the rendezvous occasion based on the UE's energy level falling below a threshold. During the sleep state after the rendezvous occasion, the UE may harvest energy from the ambient environment. The UE may remain in the sleep state and harvest energy until the UE has harvested enough energy to enter another rendezvous occasion. The duration for harvesting energy may be preconfigured (e.g., the duration is stored in the UE) and/or determined by the UE based on the rate of energy harvesting. The duration for harvesting energy may be indicated to the BS in a MAC CE message and/or UCI. In some aspects, the UE may skip all of the rendezvous occasions scheduled during the energy harvesting duration. In some aspects, the UE may wakeup from the sleep state after the energy harvesting duration and the rendezvous occasions may begin again shifted in time from when the UE wakes up from the energy harvesting. For example, if the next rendezvous occasion is scheduled for slot index 10 and the energy harvesting duration occurs for 6 slots, the next rendezvous occasion may begin at slot index 16.

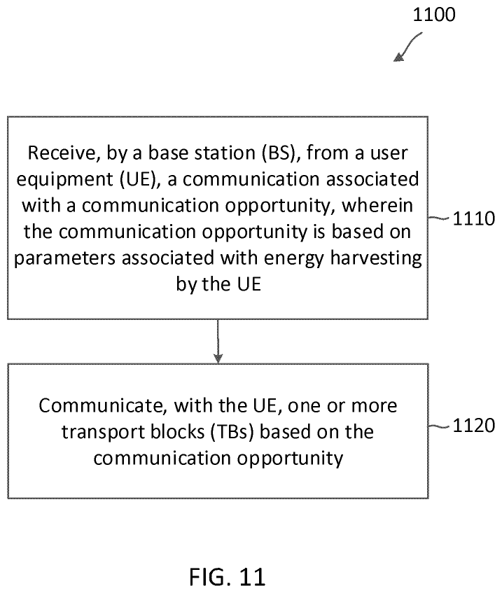

FIG. 11 is a flow diagram of a communication method 1100 according to some aspects of the present disclosure. Aspects of the method 1100 can be executed by a computing device (e.g., a processor, processing circuit, and/or other suitable component) of a wireless communication device or other suitable means for performing the aspects. For example, a wireless communication device, such as the BS 105 or BS 900, may utilize one or more components, such as the processor 902, the memory 904, the communication opportunity module 908, the energy harvesting module 909, the transceiver 910, the modem 912, and the one or more antennas 916, to execute aspects of method 1100. The method 1100 may employ similar mechanisms as in the networks 100 and 200 and the aspects and actions described with respect to FIGS. 2-7. As illustrated, the method 1100 includes a number of enumerated aspects, but the method 1100 may include additional aspects before, after, and in between the enumerated aspects. In some aspects, one or more of the enumerated aspects may be omitted or performed in a different order.

At 1110, the method 1100 includes a BS (e.g., the BS 105 or the BS 900) receiving a communication from a user equipment (UE) associated with a communication opportunity. The communication opportunity may be based on parameters associated with energy harvesting by the UE. In this regard, the UE may harvest energy from the ambient environment using any suitable method. For example, the UE may harvest (e.g., derive) energy from external sources to provide power (e.g., operating power) to the UE. The UE may harvest energy from a light source (e.g., solar radiation, photovoltaic cells, artificial light sources, etc.), an electromagnetic energy source (e.g., cellular communications, WiFi communications, NFC/RFID communications, magnetic induction, 50/60 Hz line radiation, etc.), a kinetic energy source (e.g., mechanical vibration, touchscreen press, piezoelectric source, UE motion, wearable device motion, etc.), a thermoelectric source (e.g., user body heat, IoT device heat, ambient environment heat, etc.). In some aspects, the energy harvested from the ambient environment may be stored in the UE. For example, the harvested energy may be stored in one or more batteries, capacitors, and/or other suitable storage devices. In some aspects, the UE may not have an energy storage device and the energy harvested from the ambient environment may be used by the UE as the energy is harvested. The amount of energy available to the UE for communications and/or other actions may be limited by the energy storage capacity, the amount of energy available in the ambient environment, and/or the energy harvesting method. Aspects of the present disclosure may overcome the challenges of limited energy availability in the UE using methods for coordinating communication between energy harvesting UEs and a BS. In this regard, the energy harvested by the UE may be used to communicate with a BS (e.g., the BS 105 or the BS 900).

At 1120, the method 1100 includes a BS (e.g., the BS 105 or the BS 900) communicating one or more transport blocks (TBs) with a UE (e.g., the UE 115 or the UE 800) based on the communication opportunity. The communication opportunity may be based on parameters associated with the energy harvested by the UE from the ambient environment at 1110. In this regard, the BS may receive the communication associated with the communication opportunity from the UE via a physical uplink control channel (PUCCH), a physical uplink shared channel (PUSCH), uplink control information (UCI), or other suitable communication.

In some aspects, the communication associated with the communication opportunity may include an indication of a communication periodicity and/or an indication of a communication duration. In some instances, the UE may wakeup from a low power mode (e.g., a sleep mode) to communicate with the BS based on the communication periodicity. The communication periodicity may define a communication periodicity having a start and/or an end. In some instances, the UE may wakeup at the start and/or offset from the start of the communication period. In some aspects, the communication periodicity may be based on the energy harvesting. For example, the communication periodicity or the amount of time between each communication periodicity may be based on how much energy the UE harvested during a previous time period and/or an estimate of how much energy the UE will harvest during a future time period. Additionally or alternatively, the communication duration may be based on the energy harvesting. For example, the communication duration or the amount of time the UE is in a wake state during each communication periodicity may be based on how much energy the UE harvested during a previous time period, how much harvested energy is stored in the UE, and/or an estimate of how much energy the UE will harvest during a future time period. The UE may communicate with the BS and/or directly with other UEs via sidelink communications when the UE is in the wake state during the communication duration. The communication opportunity may include a plurality of communication opportunities occurring at a frequency based on the communication periodicity.

The BS may receive communications from the UE and/or transmit communications to the UE during the communication opportunity. The BS may receive transmit one or more transport blocks (TBs) from the UE via a PUSCH during the communication opportunity. The BS may transmit one or more TBs to the UE via a PDSCH during the communication opportunity.

In some aspects, the UE may determine the communication periodicity and/or the communication duration. The BS may receive an indication of the communication periodicity and/or the communication duration from the UE via a PUCCH, a PUSCH, UCI, an RRC message, a MAC-CE message, or other suitable communication. In some aspects, the indication of the communication periodicity and/or the communication duration may include a time value (e.g., a number of ms), a multiple or a fraction of a frame, a multiple or a fraction of a subframe, a multiple or a fraction of a slot, a multiple or a fraction of a sub-slot, a multiple or a fraction of a TTI, or a multiple or a fraction of a symbol. In some aspects, the indication of the communication periodicity and/or the communication duration may include a bitmap and/or a codepoint corresponding to a time value. The UE may determine the communication periodicity and/or the communication duration using any suitable method. For example, the UE may determine the communication periodicity and/or the communication duration based on the energy harvesting capabilities of the UE and/or the energy storage capabilities of the UE. A UE with a higher energy harvesting capability and/or energy storage capability may have a shorter communication periodicity and/or a longer communication duration compared to a UE having a lower energy harvesting capability and/or energy storage capability. In some aspects, the UE may determine the communication periodicity and/or the communication duration based on a scheduled and/or estimated amount of data/control communications and the amount of energy required for the data/control communications. For example, the UE may be an IoT device scheduled to transmit/receive a number of TBs during a time frame. The UE may determine the communication periodicity and/or the communication duration based on an estimated amount of energy required to transmit and/or receive the TBs (e.g., joules per bit of data). In some aspects, the communication periodicity and/or the communication duration may be scheduled by the UE on a semi-persistent basis. The UE may update the communication periodicity and/or the communication duration schedule based on operating conditions, energy harvesting, and/or the amount of data to be communicated. The BS may receive an indication of an updated communication periodicity and/or communication duration from the UE on a periodic and/or aperiodic basis. In some aspects, the indication of an updated communication periodicity and/or communication duration may include a change field (e.g., a codepoint) where “0” indicates no change in the communication periodicity and/or communication duration and “1” indicates a change in the communication periodicity and/or communication duration. If the change field is set to “1”, the BS may receive the updated communication periodicity and/or communication duration in addition to the change field. For example, when the harvested energy, the stored energy, and/or the amount of TBs to be communicated increases, the UE may decrease the communication periodicity (e.g., increasing the frequency of communication) and/or increase the communication duration. When the harvested energy, the stored energy, and/or the amount of TBs to be communicated decreases, the UE may increase the communication periodicity (e.g., decreasing the frequency of communication) and/or decrease the communication duration.

Additionally or alternatively, the communication associated with the communication opportunity may include an indication of a communication periodicity and an indication of a communication duty cycle. The communication duty cycle may be indicated as a percent and/or a fraction of the communication period. For example, the communication duty cycle may be a communication duration divided by the communication period.

Additionally or alternatively, the BS may determine the communication duration and/or the communication period. In this regard, the BS may receive energy harvesting parameters, energy storage parameters, and/or power consumption parameters from the UE via a PUCCH, a PUSCH, UCI, an RRC message, a MAC-CE message, or other suitable communication. In some aspects, the indication of the communication periodicity and/or the communication duration may include a time value (e.g., a number of ms), a multiple or a fraction of a frame, a subframe, a slot, a sub-slot, a TTI, or a symbol. In some aspects, the indication of the communication periodicity and/or the communication duration may include a bitmap and/or a codepoint corresponding to a time value. In response, the BS may determine the communication duration and/or the communication periodicity and transmit the communication duration and/or the communication periodicity to the UE via a PDCCH, a PDSCH, DCI, an RRC message, a MAC-CE message, or other suitable communication. For example, the BS may determine the communication duration and/or the communication periodicity using a power consumption model that considers, without limitation, the energy harvesting capacity of the UE, the energy storage capacity of the UE, the amount of data to be communicated, and the UE power consumption parameters associated with the communications. The UE may report (e.g., report periodically and/or aperiodically) the power consumption parameters to the BS including, without limitation, a percent of usable energy that an empty slot may consume (e.g., energy consumed by the UE during a slot when the UE is in an RRC connected state but not receiving or transmitting data), an amount of energy consumed by the UE during reception of a PDCCH communication, an amount of energy consumed by the UE during reception of a PDSCH communication (e.g., reception of a PDSCH carrying a minimum size TB), an amount of energy consumed by the UE during transmission of a PUCCH communication, and/or an amount of energy consumed by the UE during transmission of a PUSCH communication (e.g., transmission of a PUSCH carrying a minimum size TB). In some aspects, the communication periodicity and/or the communication duration may be scheduled by the BS on a semi-persistent basis. The BS may update the communication periodicity and/or the communication duration schedule based on operating conditions and/or an amount of data to be communicated with the UE. The UE may request an updated communication periodicity and/or communication duration from the BS via a UE assistance information message and/or a MAC CE message. The BS may receive updated energy harvesting parameters and/or a buffer status report (BSR) from the UE. The BSR may indicate an amount of data to be received by the BS. In response, the BS may transmit an updated communication periodicity and/or the communication duration schedule to the UE. The communication periodicity and/or the communication duration may be updated on a periodic and/or aperiodic basis. In some aspects, the indication of an updated communication periodicity and/or communication duration may include a change field (e.g., a codepoint) where “0” indicates no change in the communication periodicity and/or communication duration and “1” indicates a change in the communication periodicity and/or communication duration. If the change field is set to “1”, the BS may transmit the updated communication periodicity and/or communication duration to the UE in addition to the change field. For example, when the harvested energy, the stored energy, or the amount of TBs to be communicated increases, the BS may decrease the communication periodicity and/or increase the communication duration. When the harvested energy, the stored energy, or the amount of TBs to be communicated decrease, the BS may increase the communication periodicity and/or decrease the communication duration.

As an alternative to reporting the power consumption parameters to the BS as a percent of usable energy, the UE may report (e.g., report periodically and/or aperiodically) the power consumption parameters as multiples of a base power level. The base power level may be the energy (e.g., a number of joules and/or a percent of the UE's usable amount of energy) that an empty slot may consume (e.g., energy consumed by the UE during a slot when the UE is in an RRC connected state but not receiving or transmitting data). The UE may report the base power level, a multiplier of the base power level indicating an amount of energy consumed by the UE during reception of a PDCCH communication, a multiplier of the base power level indicating an amount of energy consumed by the UE during reception of a PDSCH communication (e.g., reception of a PDSCH carrying a minimum size TB), a multiplier of the base power level indicating an amount of energy consumed by the UE during transmission of a PUCCH communication, and/or a multiplier of the base power level indicating an amount of energy consumed by the UE during transmission of a PUSCH communication (e.g., transmission of a PUSCH carrying a minimum size TB).

In some aspects, the BS may receive an indicator from the UE indicating an early termination of a communication duration. The BS may receive the communication termination indicator based on the UE having transmitted all the data in the UE's buffer. Additionally or alternatively, the BS may receive the communication termination indicator based on the UE having a low usable energy level (e.g., the stored and/or harvested energy is below a threshold) and/or other power parameters associated with the UE. In this regard, the BS may receive the communication termination indicator in a PUCCH communication, a PUSCH communication, UCI, an UL DRX MAC CE, or other suitable communication. In some aspects, the communication termination indicator may be a codepoint (e.g., a single bit 0 or 1) indicating whether the communication duration should be terminated before the end of the scheduled communication duration. In some instances, the codepoint may be indicated via a PUCCH message and/or multiplexed with HARQ feedback to the BS. Additionally or alternatively, the termination indicator may be an indication (e.g., an explicit indication) of when the communication duration should terminate (e.g., a time to when the UE enters a sleep state). The termination indicator may be an amount of time from the start of the communication duration, an amount of time from the end of the communication duration, a delta amount of time from a previous termination indicator, or other suitable termination indicator. In some aspects, the termination indicator may include a time value (e.g., a number of ms), a multiple or a fraction of a frame, a multiple or a fraction of a subframe, a multiple or a fraction of a slot, a multiple or a fraction of a sub-slot, a multiple or a fraction of a TTI, or a multiple or a fraction of a symbol. In some aspects, the indication of the termination indicator may include a bitmap and/or a codepoint corresponding to a time value.

In some aspects, the BS may indicate an early termination of a communication duration. In this regard, the BS may indicate early termination of the communication duration via a DRX MAC CE message, a time to dormancy (TTD) MAC CE message, a MAC CE message, and/or DCI. In some aspects, the BS may transmit an indicator to the UE indicating when to terminate the communication (e.g., early termination) based on when the BS has no more data to transmit to the UE. The UE may enter a sleep state after receiving the communication duration termination indicator from the BS.

In some aspects, the BS may receive information from the UE to assist the BS in scheduling the communication periodicity and/or communication duration. For example, the BS may receive an energy status report from the UE indicating the percent energy remaining in the UE. In some instances, the energy status report may be based on a power consumption model as described above. In this regard, the BS may receive the energy status report from the UE via a MAC CE message or other suitable communication.

Additionally or alternatively, the BS may receive UE assistance information from the UE to assist the BS in scheduling the communication periodicity and/or communication duration. In this regard, the BS may receive the UE assistance information via an RRC message, UCI, an UL MAC CE, or other suitable communication. The UE assistance information may include, without limitation, a bandwidth part for communication, a frequency band, a subcarrier spacing (SCS), a modulation and coding scheme (MCS), a maximum TB size, and/or a minimum TB size. In some aspects, the BS may receive the UE assistance information when the UE assistance information prohibit timer is not running. The UE assistance information prohibit timer may be a timer that indicates when the UE may transmit the UE assistance information. In some aspects, the BS may transmit an indicator to the UE that configures the UE assistance information prohibit timer. The BS may transmit an indicator to the UE that indicates when the UE assistance information prohibit timer shall start (e.g., timer running) and stop (e.g., timer not running). The UE may refrain from transmitting the UE assistance information to the BS when the UE assistance information prohibit timer is running.

Additionally or alternatively, the BS and the UE may establish (e.g., preconfigure) a sequence of rendezvous occasions. The BS and UE may communicate with each other during the rendezvous occasions. Each rendezvous occasion may have a fixed or variable time duration. The rendezvous occasions may occur at a fixed or variable periodicity. The timing of the rendezvous occasions may be synchronized between the UE and the BS such that the UE and the BS are both in a wake state during the rendezvous occasions. In some aspects, the BS may receive a rendezvous occasion schedule including a rendezvous duration and periodicity from the UE. In response, the BS may confirm the rendezvous occasion schedule or transmit a different rendezvous occasion schedule to the UE. In some aspects, when the UE and BS do not have data to communicate, the UE may enter a sleep state. For example, the UE may wake up during a rendezvous occasion and receive an indicator (e.g., a BSR) from the BS indicating the BS has no data to transmit to the UE. In response to the indicator indicating the BS has no data to transmit, the UE may enter a sleep state and remain in the sleep state until the next rendezvous occasion. In some aspects, when either the UE or the BS has data to communicate, the UE may wakeup during the rendezvous occasion and remain in a wake state until there is no more data to communicate and/or the energy associated with the UE has fallen below a threshold. In this case, the UE may wake up during the next rendezvous occasion when the energy associated with the UE has increased above a threshold. In some aspects, the BS may receive an indicator from the UE indicating when the UE expects to have no more data to communicate or when the energy associated with the UE is expected to fall below the threshold.

In some aspects, the UE may enter or remain in a sleep state for a duration (e.g., a minimum duration) after the rendezvous occasion. The UE may enter or remain in a sleep state for the duration after the rendezvous occasion based on the UE's energy level falling below a threshold. During the sleep state after the rendezvous occasion, the UE may harvest energy from the ambient environment. The UE may remain in the sleep state and harvest energy until the UE has harvested enough energy to enter another rendezvous occasion. The duration for harvesting energy may be preconfigured (e.g., the duration is stored in the UE) and/or determined by the UE based on the rate of energy harvesting. The duration for harvesting energy may be indicated to the BS in a MAC CE message and/or UCI. In some aspects, the UE may skip all of the rendezvous occasions scheduled during the energy harvesting duration. In some aspects, the UE may wakeup from the sleep state after the energy harvesting duration and the rendezvous occasions may begin again shifted in time from when the UE wakes up from the energy harvesting. For example, if the next rendezvous occasion is scheduled for slot index 10 and the energy harvesting duration occurs for 6 slots, the next rendezvous occasion may begin at slot index 16.

Further aspects of the present disclosure include the following:

Aspect 1 includes a method of wireless communication performed by a first sidelink user equipment (UE), the method comprising harvesting energy from an ambient environment associated with the UE; and transmitting, to a base station (BS), a communication associated with a communication opportunity, wherein the communication opportunity is based on parameters associated with the harvesting of the energy from the ambient environment.

Aspect 2 includes the method of aspect 1 further comprising communicating, with the BS, one or more transport blocks (TBs) based on the communication opportunity.

Aspect 3 includes the method of any of aspects 1-2, wherein the communication associated with the communication opportunity comprises an indication of a communication periodicity and an indication of a communication duration.

Aspect 4 includes the method of any of aspects 1-3, wherein the communication associated with the communication opportunity comprises an indication of a communication duty cycle.

Aspect 5 includes the method of any of aspects 1-4, further comprising transmitting, to the BS, the parameters; and receiving, from the BS, an indication of a communication periodicity based on the parameters and an indication of a communication duration based on the parameters.

Aspect 6 includes the method of any of aspects 1-5, wherein the parameters comprise at least one of an amount of energy consumed by the UE during a slot; an amount of energy consumed by the UE during reception of a physical downlink control channel (PDCCH) communication; an amount of energy consumed by the UE during reception of a physical downlink shared channel (PDSCH) communication; an amount of energy consumed by the UE during transmission of a physical uplink control channel (PUCCH) communication: or an amount of energy consumed by the UE during transmission of a physical uplink shared channel (PUSCH) communication.

Aspect 7 includes the method of any of aspects 1-6, further comprising transmitting, to the BS, an indicator indicating termination of the communication opportunity.

Aspect 8 includes the method of any of aspects 1-7, wherein the indicator comprises an indication of a time period based on the parameters.

Aspect 9 includes the method of any of aspects 1-8, wherein the communication associated with the communication opportunity comprises an indication of a communication duration; and the method further comprises transmitting, to the BS, a buffer status report (BSR); and communicating, with the BS and based on the BSR, one or more transport blocks (TBs) after the communication duration

Aspect 10 includes the method of any of aspects 1-9, wherein the communication opportunity comprises a communication duration; and the harvesting energy from the ambient environment associated with the UE comprises harvesting energy from the ambient environment for a minimum time duration after the communication duration

Aspect 11 includes the method of any of aspects 1-10, further comprising entering a sleep state for the minimum time duration after the communication duration

Aspect 12 includes the method of any of aspects 1-11, further comprising entering a wake state after the minimum time duration.

Aspect 13 includes the method of any of aspects 1-12, further comprising entering a wake state based on an amount of energy harvested from the ambient environment.

Aspect 14 includes the method of any of aspects 1-13, further comprising transmitting, to the BS, UE assistance information comprising at least one of an energy status report: a bandwidth associated with the communication opportunity: a modulation and coding scheme (MCS); or a maximum transport block size, wherein the communication opportunity is further based on the UE assistance information.

Aspect 15 includes the method of any of aspects 1-14, wherein the energy status report indicates an amount of usable energy associated with the UE.

Aspect 16 includes the method of any of aspects 1-15, wherein the harvesting of the energy from the ambient environment comprises at least one of harvesting electromagnetic energy from the ambient environment; harvesting kinetic energy from the ambient environment: harvesting thermal energy from the ambient environment: or harvesting light energy from the ambient environment.

Aspect 17 includes a method of wireless communication performed by a base station (BS), the method comprising receiving, from a user equipment (UE), a communication associated with a communication opportunity, wherein the communication opportunity is based on parameters associated with energy harvesting by the UE; and communicating, with the UE, one or more transport blocks (TBs) based on the communication opportunity.

Aspect 18 includes the method of aspect 17, wherein the communication associated with the communication opportunity comprises an indication of a communication periodicity and an indication of a communication duration.

Aspect 19 includes the method of any of aspects 17 or 18, wherein the communication associated with the communication opportunity comprises an indication of a communication duty cycle.

Aspect 20 includes method of any of aspects 17-19, further comprising receiving, from the UE, the parameters; and transmitting, to the UE, an indication of a communication periodicity based on the parameters and an indication of a communication duration based on the parameters.

Aspect 21 includes method of any of aspects 17-20, wherein the parameters comprise at least one of an amount of energy consumed by the UE during a slot: an amount of energy consumed by the UE during reception of a physical downlink control channel (PDCCH) communication: an amount of energy consumed by the UE during reception of a physical downlink shared channel (PDSCH) communication: an amount of energy consumed by the UE during transmission of a physical uplink control channel (PUCCH) communication: or n amount of energy consumed by the UE during transmission of a physical uplink shared channel (PUSCH) communication.

Aspect 22 includes method of any of aspects 17-21, further comprising receiving, from the UE, an indicator indicating termination of the communication opportunity.

Aspect 23 includes method of any of aspects 17-22, wherein the indicator comprises an indication of a time period based on the parameters.

Aspect 24 includes method of any of aspects 17-23, wherein the communication associated with the communication opportunity comprises an indication of a communication duration; and the method further comprises receiving, from the UE, a buffer status report (BSR); and communicating, with the UE and based on the BSR, one or more transport blocks (TBs) after the communication duration

Aspect 25 includes method of any of aspects 17-24, further comprising harvesting energy from an ambient environment associated with the BS.

Aspect 26 includes method of any of aspects 17-25, further comprising receiving, from the UE, UE assistance information comprising at least one of an energy status report: a bandwidth associated with the communication opportunity: a modulation and coding scheme (MCS): or a maximum transport block size, wherein the communication opportunity is further based on the UE assistance information.

Aspect 27 includes method of any of aspects 17-26, wherein the energy status report indicates an amount of usable energy associated with the UE.

Aspect 28 includes the method of any of aspects 17-27, wherein the harvesting of the energy comprises at least one of harvesting electromagnetic energy from an ambient environment: harvesting kinetic energy from the ambient environment; harvesting thermal energy from the ambient environment: or harvesting light energy from the ambient environment.

Aspect 29 includes a non-transitory computer-readable medium storing one or more instructions for wireless communication, the one or more instructions comprising one or more instructions that, when executed by one or more processors of a user equipment (UE), cause the one or more processors to perform any one of aspects 1-16.

Aspect 30 includes a non-transitory computer-readable medium storing one or more instructions for wireless communication, the one or more instructions comprising one or more instructions that, when executed by one or more processors of a base station (BS), cause the one or more processors to perform any one of aspects 17-28.

Aspect 31 includes a user equipment (UE) comprising one or more means to perform any one or more of aspects 1-16.

Aspect 32 includes a base station (BS) comprising one or more means to perform any one or more of aspects 17-28.

Aspect 33 includes a user equipment (UE) comprising a memory, a transceiver and at least one processor coupled to the memory and the transceiver, wherein the UE is configured to perform any one or more of aspects 1-16.

Aspect 34 includes a base station (BS) comprising a memory, a transceiver and at least one processor coupled to the memory and the transceiver, wherein the BS is configured to perform any one or more of aspects 17-28.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

1. A user equipment (UE), comprising:
one or more memories; and
one or more processors coupled to the one or more memories, the one or more memories storing instructions executable by the one or more processors, individually or in any combination, to cause the UE to:
harvest energy from an ambient environment associated with the UE; and
transmit, to a network unit, a communication associated with a communication opportunity, wherein the communication opportunity is based on parameters associated with the harvesting of the energy from the ambient environment.

2. The UE of claim 1, wherein the one or more memories store instructions executable by the one or more processors, individually or in any combination, to further cause the UE to:
communicate, with the network unit, one or more transport blocks (TBs) based on the communication opportunity.

3. The UE of claim 1, wherein the communication associated with the communication opportunity comprises an indication of a communication periodicity and an indication of a communication duration.

4. The UE of claim 1, wherein the communication associated with the communication opportunity comprises an indication of a communication duty cycle.

5. The UE of claim 1, wherein the one or more memories store instructions executable by the one or more processors, individually or in any combination, to further cause the UE to:
transmit, to the network unit, the parameters; and
receive, from the network unit, an indication of a communication periodicity based on the parameters and an indication of a communication duration based on the parameters.

6. The UE of claim 5, wherein the parameters comprise at least one of:
an amount of energy consumed by the UE during a slot;
an amount of energy consumed by the UE during reception of a physical downlink control channel (PDCCH) communication;
an amount of energy consumed by the UE during reception of a physical downlink shared channel (PDSCH) communication;
an amount of energy consumed by the UE during transmission of a physical uplink control channel (PUCCH) communication; or
an amount of energy consumed by the UE during transmission of a physical uplink shared channel (PUSCH) communication.

7. The UE of claim 1, wherein the one or more memories store instructions executable by the one or more processors, individually or in any combination, to further cause the UE to:
transmit, to the network unit, an indicator indicating termination of the communication opportunity.

8. The UE of claim 7, wherein the indicator comprises an indication of a time period based on the parameters.

9. The UE of claim 1, wherein the communication associated with the communication opportunity comprises an indication of a communication duration; and
the one or more memories store instructions executable by the one or more processors, individually or in any combination, to further cause the UE to:
transmit, to the network unit, a buffer status report (BSR); and
communicate, with the network unit and based on the BSR, one or more transport blocks (TBs) after the communication duration.

10. The UE of claim 1, wherein:
the communication opportunity comprises a communication duration; and
the one or more memories store instructions executable by the one or more processors, individually or in any combination, to further cause the UE to:
harvest energy from the ambient environment for a minimum time duration after the communication duration.

11. The UE of claim 10, wherein the one or more memories store instructions executable by the one or more processors, individually or in any combination, to further cause the UE to:
enter a sleep state for the minimum time duration after the communication duration.

12. The UE of claim 11, wherein the one or more memories store instructions executable by the one or more processors, individually or in any combination, to further cause the UE to:
enter a wake state after the minimum time duration.

13. The UE of claim 11, wherein the one or more memories store instructions executable by the one or more processors, individually or in any combination, to further cause the UE to:
enter a wake state based on an amount of energy harvested from the ambient environment.

14. The UE of claim 1, wherein the one or more memories store instructions executable by the one or more processors, individually or in any combination, to further cause the UE to:
transmit, to the network unit, UE assistance information comprising at least one of:
an energy status report;
a bandwidth associated with the communication opportunity;
a modulation and coding scheme (MCS); or
a maximum transport block size,
wherein the communication opportunity is further based on the UE assistance information.

15. The UE of claim 14, wherein the energy status report indicates an amount of usable energy associated with the UE.

16. The UE of claim 1, wherein the one or more memories store instructions executable by the one or more processors, individually or in any combination, to further cause the UE to harvest the energy from the ambient environment by at least one of:
harvesting electromagnetic energy from the ambient environment;
harvesting kinetic energy from the ambient environment;
harvesting thermal energy from the ambient environment; or
harvesting light energy from the ambient environment.

17. A network unit, comprising:
one or more memories; and
one or more processors coupled to the one or more memories, the one or more memories storing instructions executable by the one or more processors, individually or in any combination, to cause the network unit to:
receive, from a user equipment (UE), a communication associated with a communication opportunity, wherein the communication opportunity is based on parameters associated with energy harvesting by the UE; and
communicate, with the UE, one or more transport blocks (TBs) based on the communication opportunity.

18. The network unit of claim 17, wherein the communication associated with the communication opportunity comprises an indication of a communication periodicity and an indication of a communication duration.

19. The network unit of claim 17, wherein the communication associated with the communication opportunity comprises an indication of a communication duty cycle.

20. The network unit of claim 17, wherein the one or more memories store instructions executable by the one or more processors, individually or in any combination, to further cause the network unit to:
receive, from the UE, the parameters; and
transmit, to the UE, an indication of a communication periodicity based on the parameters and an indication of a communication duration based on the parameters.

21. The network unit of claim 20, wherein the parameters comprise at least one of:
an amount of energy consumed by the UE during a slot;
an amount of energy consumed by the UE during reception of a physical downlink control channel (PDCCH) communication;
an amount of energy consumed by the UE during reception of a physical downlink shared channel (PDSCH) communication;
an amount of energy consumed by the UE during transmission of a physical uplink control channel (PUCCH) communication; or
an amount of energy consumed by the UE during transmission of a physical uplink shared channel (PUSCH) communication.

22. The network unit of claim 17, wherein the one or more memories store instructions executable by the one or more processors, individually or in any combination, to further cause the network unit to:
receive, from the UE, an indicator indicating termination of the communication opportunity.

23. The network unit of claim 22, wherein the indicator comprises an indication of a time period based on the parameters.

24. The network unit of claim 17, wherein the communication associated with the communication opportunity comprises an indication of a communication duration; and
the one or more memories store instructions executable by the one or more processors, individually or in any combination, to further cause the network unit to:
receive, from the UE, a buffer status report (BSR); and
communicate, with the UE and based on the BSR, one or more transport blocks (TBs) after the communication duration.

25. The network unit of claim 17, wherein the one or more memories store instructions executable by the one or more processors, individually or in any combination, to further cause the network unit to:
harvest energy from an ambient environment associated with the network unit.

26. The network unit of claim 17, wherein the one or more memories store instructions executable by the one or more processors, individually or in any combination, to further cause the network unit to:
receive, from the UE, UE assistance information comprising at least one of:
an energy status report;
a bandwidth associated with the communication opportunity;
a modulation and coding scheme (MCS); or
a maximum transport block size,
wherein the communication opportunity is further based on the UE assistance information.

27. The network unit of claim 26, wherein the energy status report indicates an amount of usable energy associated with the UE.

28. The network unit of claim 25, wherein the one or more memories store instructions executable by the one or more processors, individually or in any combination, to further cause the network unit to harvest the energy from the ambient environment by at least one of:
harvesting electromagnetic energy from an ambient environment;
harvesting kinetic energy from the ambient environment;
harvesting thermal energy from the ambient environment; or
harvesting light energy from the ambient environment.

29. A method of wireless communication performed by a user equipment (UE), the method comprising:
harvesting energy from an ambient environment associated with the UE; and
transmitting, to a network unit, a communication associated with a communication opportunity, wherein the communication opportunity is based on parameters associated with the harvesting of the energy from the ambient environment.

30. A method of wireless communication performed by a network unit, the method comprising:
receiving, from a user equipment (UE), a communication associated with a communication opportunity, wherein the communication opportunity is based on parameters associated with energy harvesting by the UE; and
communicating, with the UE, one or more transport blocks (TBs) based on the communication opportunity.
